(19) United States
(12) Patent Application Publication
(10) Pub. No.: US 2016/0094866 A1
(43) Pub. Date: Mar. 31, 2016

(54) USER INTERACTION ANALYSIS MODULE

(71) Applicant: Amazon Technologies, Inc., Reno, NV (US)

(72) Inventors: MICHAEL ANTHONY FRAZZINI, SEATTLE, WA (US); COLLIN CHARLES DAVIS, SEATTLE, WA (US); GERARD JOSEPH HEINZ, II, SEATTLE, WA (US); MICHAEL SCHLEIF PESCE, SEATTLE, WA (US)

(73) Assignee: AMAZON TECHNOLOGIES, INC., Reno, NV (US)

(21) Appl. No.: 14/500,451

(22) Filed: Sep. 29, 2014

(51) Int. Cl. H04N 21/2668; H04N 21/81; H04N 21/2343; H04N 21/472; H04N 21/442; H04N 21/234

(52) U.S. Cl. CPC H04N 21/2668; H04N 21/44222; H04N 21/23412; H04N 21/23418; H04N 21/23439; H04N 21/47205; H04N 21/812; H04N 21/8126; H04N 21/8173

(57) ABSTRACT

An interaction analysis module may collect data about user interactions with video content in a real-time video exploration (RVE) system, analyze the collected data to determine correlations between users or groups of users and particular video content, and provide the analysis data to one or more systems, for example to the RVE system or to an online merchant. The RVE system may dynamically render and stream new video content targeted at particular users or groups based at least in part on the analysis data. Network-based computation resources and services may be leveraged by the RVE system to enable interactive exploration of video content by the users, as well as the real-time rendering and streaming of the new video content. Entities such as online merchants may target information such as advertising or recommendations to particular users or groups based at least in part on the analysis information.

### BACKGROUND

Much video content produced today, including but not limited to movies, television and cable programs, and games, is at least partially generated using two-dimensional (2D) or three-dimensional (3D) computer graphics techniques. For example, video content for online multiplayer games and modern animated movies may be generated using various computer graphics techniques as implemented by various graphics applications to generate 2D or 3D representations or models of scenes, and then applying rendering techniques to render 2D representations of the scenes. As another example, scenes in some video content may be generated by filming live actor(s) using green- or blue-screen technology, and filling in the background and/or adding other content or effects using one or more computer graphics techniques.

Generating a scene using computer graphics techniques may, for example, involve generating a background for the scene, generating one or more objects for the scene, combining the background and objects(s) into a representation or model of the scene, and applying rendering techniques to render a representation of the model of the scene as output. Each object in a scene may be generated according to an object model that includes but is not limited to an object frame or shape (e.g., a wire frame), surface texture(s), and color(s). Rendering of a scene may include applying global operations or effects to the scene such as illumination, reflection, shadows, and simulated effects such as rain, fire, smoke, dust, and fog, and may also include applying other techniques such as animation techniques for the object(s) in the scene. Rendering typically generates as output sequences of 2D video frames for the scenes, and the video frame sequences may be joined, merged, and edited as necessary to generate final video output, for example a movie or game sequence.

### BRIEF DESCRIPTION OF THE DRAWINGS

FIG. 1 is a high-level illustration of an example real-time video encoding (RVE) system in which interaction analysis methods and an interaction analysis module may be implemented, according to at least some embodiments.

FIG. 2 is a high-level flowchart of a method for analyzing user interactions with video content and providing targeted content or information based at least in part on the analysis, according to at least some embodiments.

FIG. 3 is a high-level flowchart of a method for analyzing user interactions with video content and rendering and streaming new video content based at least in part on the analysis, according to at least some embodiments.

FIG. 4 is a high-level flowchart of a method for analyzing user interactions with video content and correlating the analysis data with client information obtained from one or more sources, according to at least some embodiments.

FIG. 5A is a high-level flowchart of a method for determining correlations between groups of users and video content according to analysis of user interactions with the video content and targeting content or information at particular users based at least in part on the group correlation data, according to at least some embodiments.

FIG. 5B is a high-level flowchart of a method for targeting content or information at groups at least in part according to analysis of a particular user's interactions with video content, according to at least some embodiments.

FIG. 6 is a block diagram illustrating an example real-time video exploration (RVE) system and environment in which user interactions with video content are analyzed to determine correlations between users and content, according to at least some embodiments.

FIG. 7 is a block diagram that graphically illustrates a multiplayer game in an example computer-based multiplayer game environment in which user interactions with game video content may be analyzed to determine correlations between users or players and content, according to at least some embodiments.

FIG. 8 is a high-level illustration of an interaction analysis service, according to at least some embodiments.

FIG. 9 is a high-level illustration of a real-time video exploration (RVE) system, according to at least some embodiments.

FIG. 10 is a flowchart of a method for exploring modeled worlds in real-time during playback of pre-recorded video, according to at least some embodiments.

FIG. 11 is a flowchart of a method for interacting with objects and rendering new video content of the manipulated objects while exploring a video being played back, according to at least some embodiments.

FIG. 12 is a flowchart of a method for modifying and ordering objects while exploring a video being played back, according to at least some embodiments.

FIG. 13 is a flowchart of a method for rendering and storing new video content during playback of pre-recorded video, according to at least some embodiments.

FIG. 14 illustrates an example network-based RVE environment, according to at least some embodiments.

FIG. 15 illustrates an example network-based environment in which a streaming service is used to stream rendered video to clients, according to at least some embodiments.

FIG. 16 is a diagram illustrating an example provider network environment in which embodiments as described herein may be implemented.

FIG. 17 is a block diagram illustrating an example computer system that may be used in some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of methods and apparatus for collecting, analyzing, and leveraging user interactions with video content are described. Video content, including but not limited to video content for movies, television and cable programs, and games, may be produced using two-dimensional (2D) or three-dimensional (3D) computer graphics techniques to generate 2D or 3D modeled worlds for scenes and render 2D representations of the modeled worlds as output. 2D or 3D production techniques may be used, for example, in producing fully rendered, animated video content according to computer graphics techniques, as well as in producing partially rendered video content that involves filming live action using green- or blue-screen technology and filling in the background and/or adding other content or effects using computer graphics techniques.

2D or 3D graphics data may be used in generating and rendering the content in the scenes for video according to the computer graphics techniques. For a given scene, the graphics data may include, but is not limited to, 2D or 3D object model data such as object frames or shapes (e.g., wire frames), wraps for the frames, surface textures and patterns, colors, animation models, and so on, that is used to generate models of objects for the scene; general scene information such as surfaces, vanishing points, textures, colors, lighting sources, and so on; information for global operations or effects in the scenes such as illumination, reflection, shadows, and simulated effects such as rain, fire, smoke, dust, and fog; and in general any information or data that may be used in generating a modeled world for the scene and in rendering 2D representations of the world (e.g., video frames) as video output. In some embodiments, the 2D or 3D graphics data may include data used to render objects representing particular types of devices, particular products, particular brands of products, and so on.

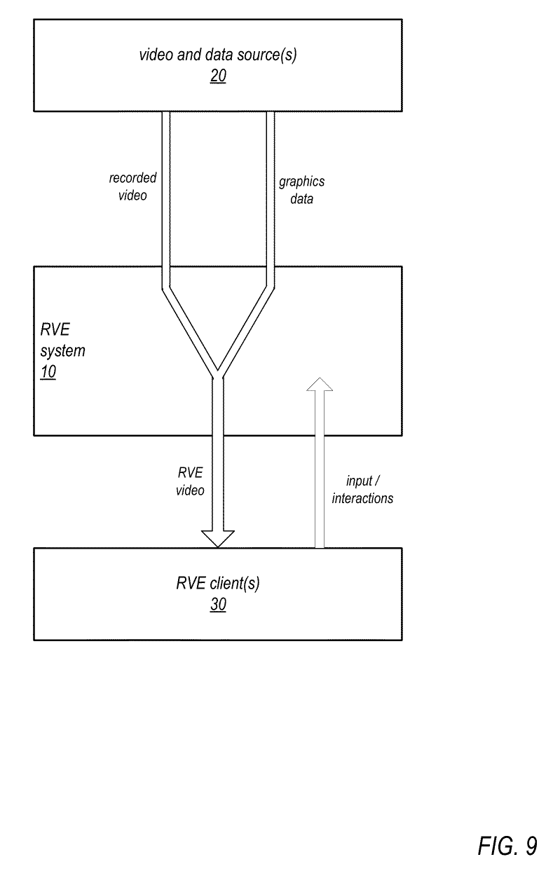

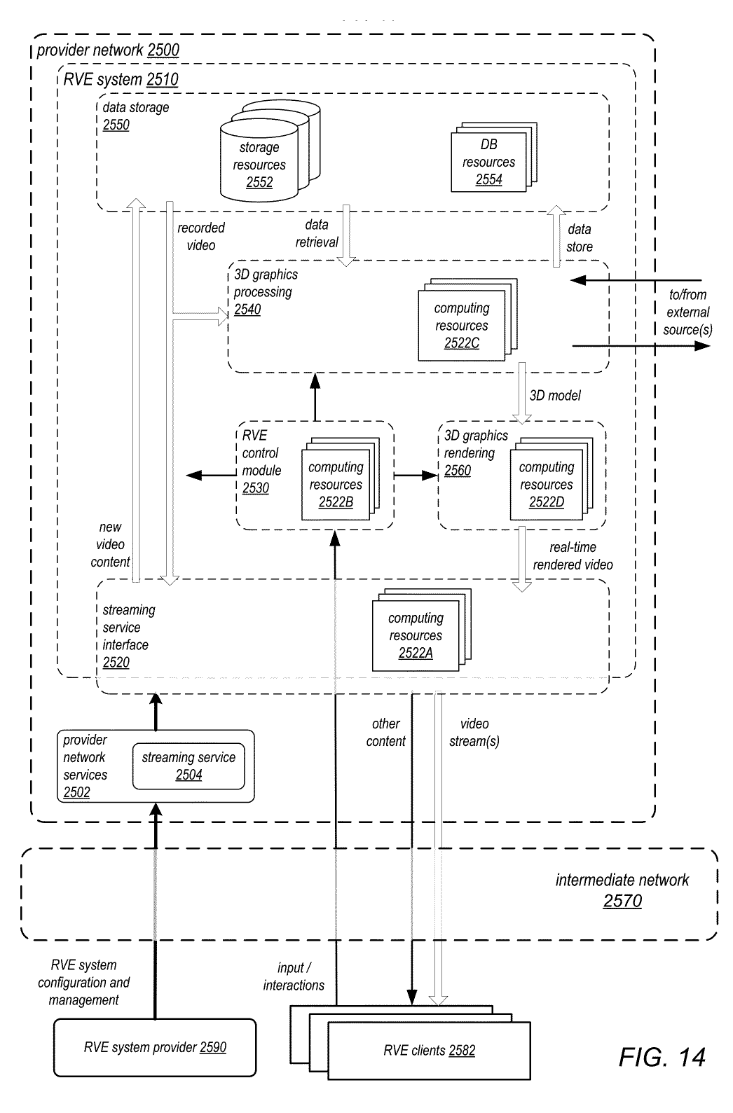

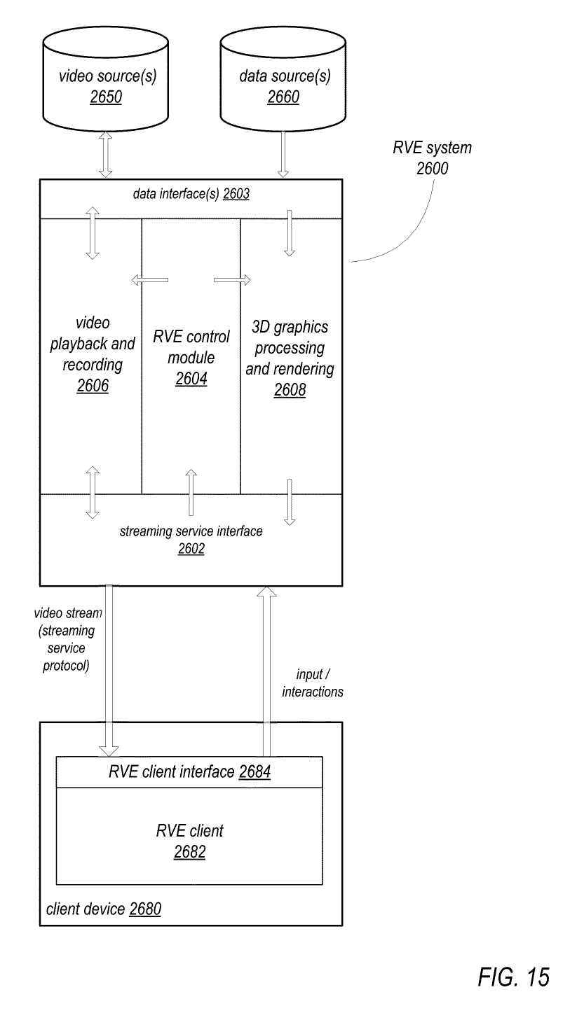

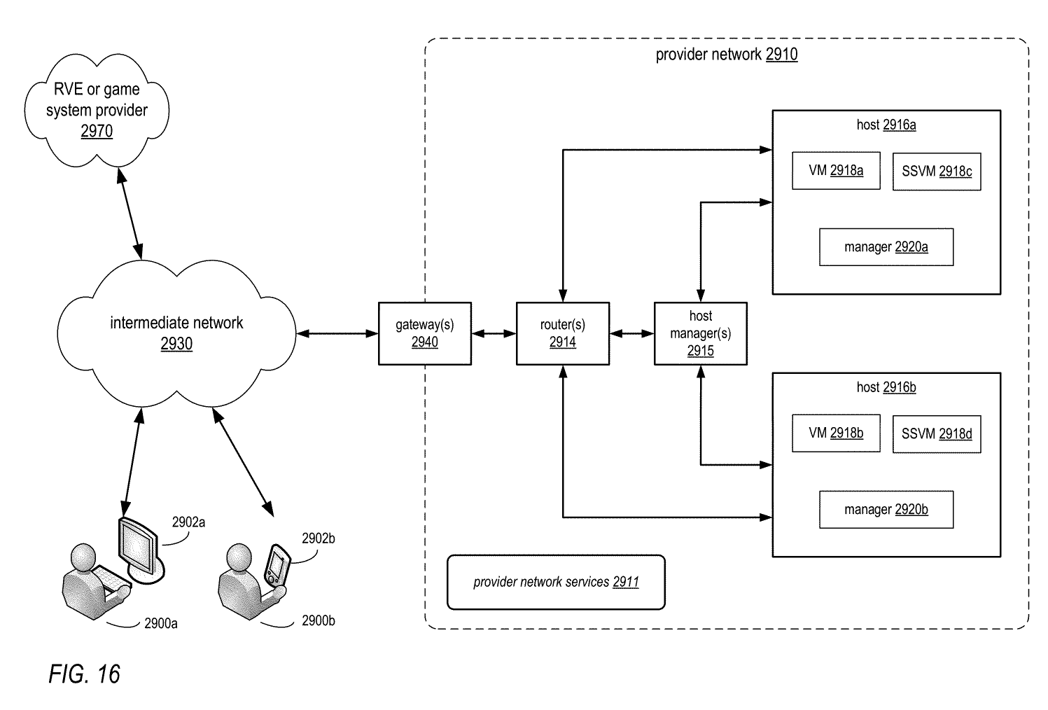

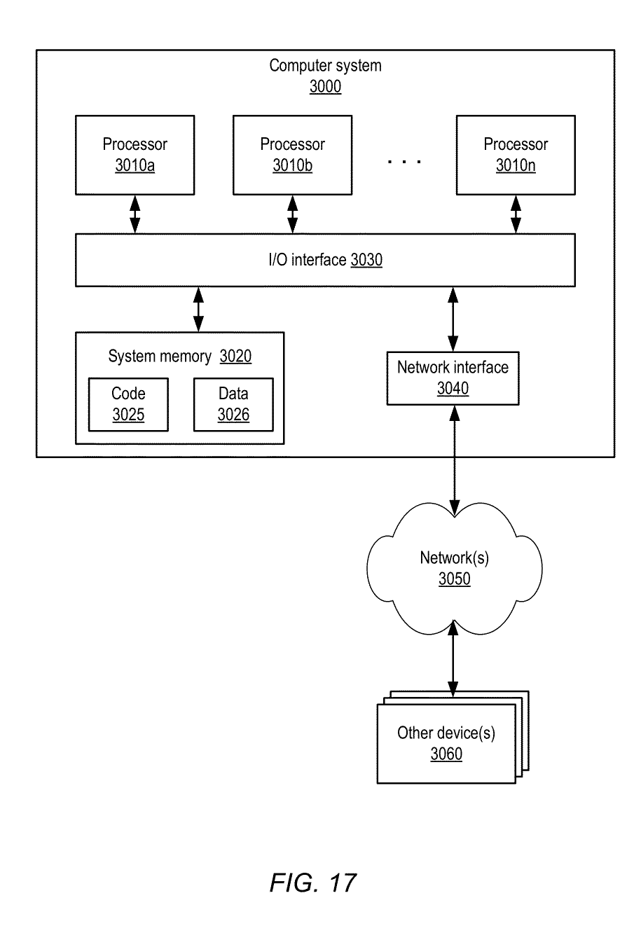

A real-time video exploration (RVE) system may leverage this 2D or 3D graphics data and network-based computation resources and services to enable interactive exploration of 2D or 3D modeled worlds by users from within video being played to respective client devices. FIGS. 9 through 13 illustrate example embodiments of RVE methods, systems, and apparatus. An RVE system may generate, render, and stream new video content to client devices in response to user interactions with and within the video content. An RVE system may, for example, allow a user to step into a scene in a video to explore, manipulate, and modify video content in a modeled world via an RVE client interface. The computational power available through the network-based computation resources may allow the RVE system to provide low-latency responses to the user's interactions with the modeled world as viewed on a respective client device, thus providing a responsive and interactive exploratory experience to the user. FIG. 14 illustrates an example network environment in which network-based computation resources are leveraged to provide real-time, low-latency rendering and streaming of video content that may be used to implement an RVE system as described herein. FIG. 15 illustrates an example network-based environment in which a streaming service is used to stream rendered video to clients, according to at least some embodiments. FIG. 16 illustrates an example provider network environment in which embodiments of an RVE system as described herein may be implemented. FIG. 17 is a block diagram illustrating an example computer system that may be used in some embodiments.

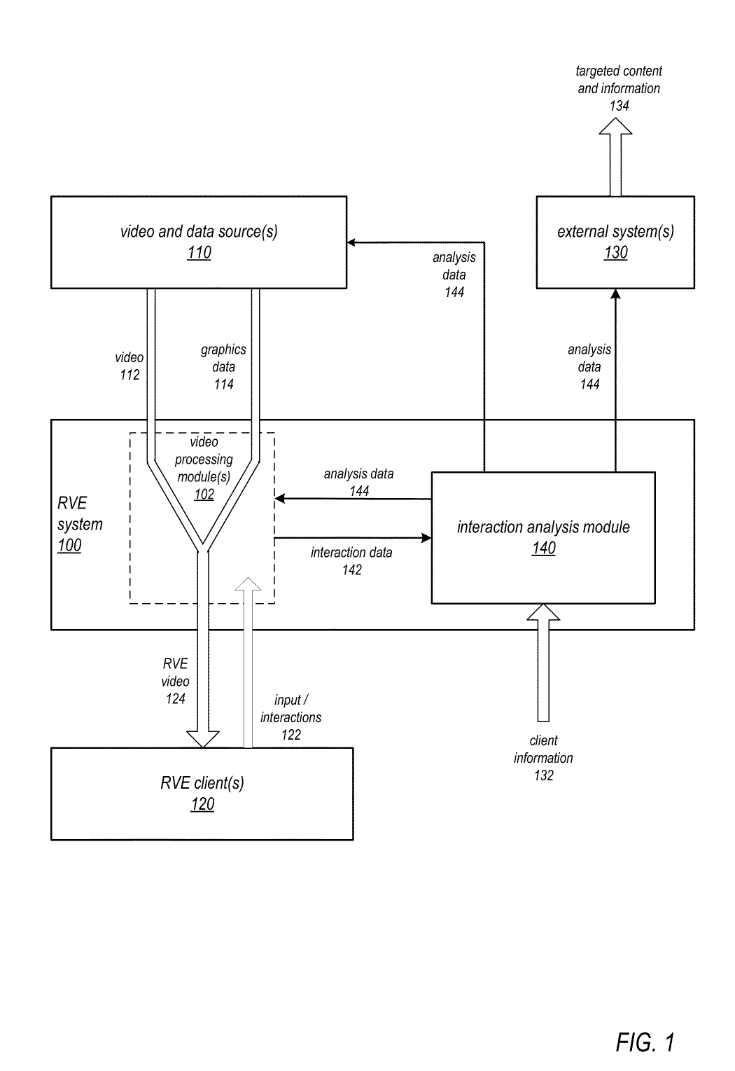

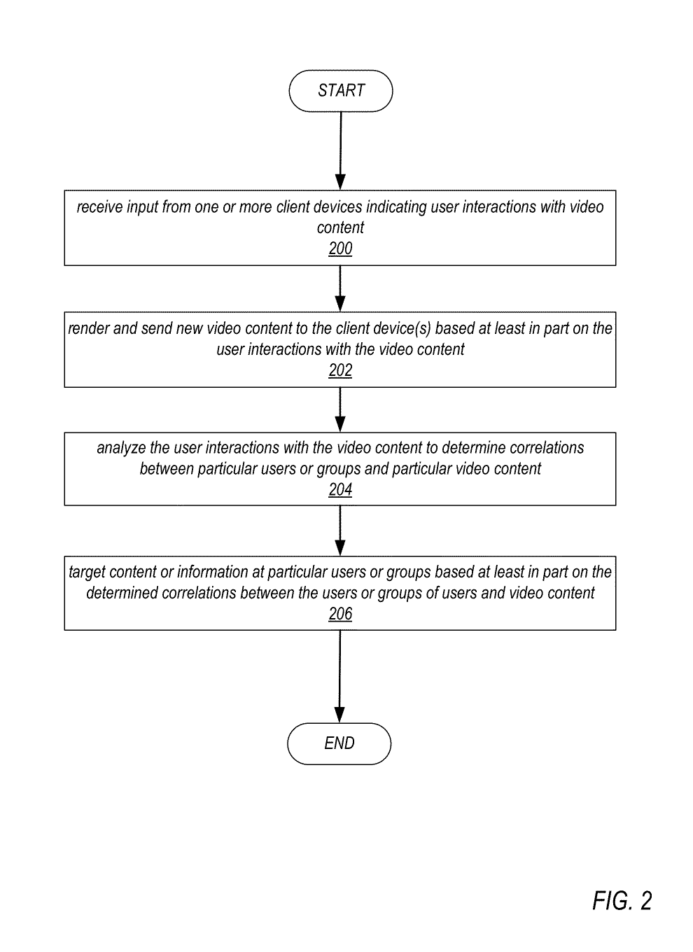

Embodiments of interaction analysis methods and modules are described that may collect information about user interactions with video content within a real-time video exploration (RVE) system, analyze the collected information to determine correlations between users and video content, and provide content or information targeted at particular users or groups of users based at least in part on the determined correlations. FIG. 1 is a high-level illustration of an example real-time video exploration (RVE) system 100 in which interaction analysis methods and an interaction analysis module 140 may be implemented, according to at least some embodiments. FIGS. 2 through 5 illustrate example interaction analysis methods that may be implemented within the RVE system 100 of FIG. 1, according to various embodiments.

As shown in FIG. 1, in some embodiments, an RVE system 100 may include one or more video processing modules 102 that play back video 112 from one or more sources 110 to one or more RVE clients 120, receive user input/interactions 122 with video content within scenes being explored from respective RVE clients 120, responsively generate or update 2D or 3D models from graphics data 114 obtained from one or more sources 110 in response to the user input/interactions 122 exploring the video content within the scenes, render new video content for the scenes at least in part from the generated models, and deliver the newly rendered video content (and audio, if present) to the respective RVE clients 120 as RVE video 124 content. Thus, rather than just viewing a pre-rendered scene in a video 112, a user may step into and explore the scene from different angles, wander around the scene at will within the scope of the modeled world, discover hidden objects and/or parts of the scene that are not visible in the original video 112, and explore, manipulate, and modify video content (e.g., rendered objects) within the modeled world.

As shown in FIG. 1, in some embodiments, an RVE system 100 may include an interaction analysis module 140 that may collect or otherwise obtain interaction data 142 (e.g., information about user interactions 122 with video content within the RVE system 100) and analyze the interaction data 142 to determine correlations between users and video content. In some embodiments, the RVE system 100 and/or one or more external systems 130 may provide content or information targeted at particular users or groups of users based at least in part on the determined correlations as indicated in analysis data 144 output from interaction analysis module 140.

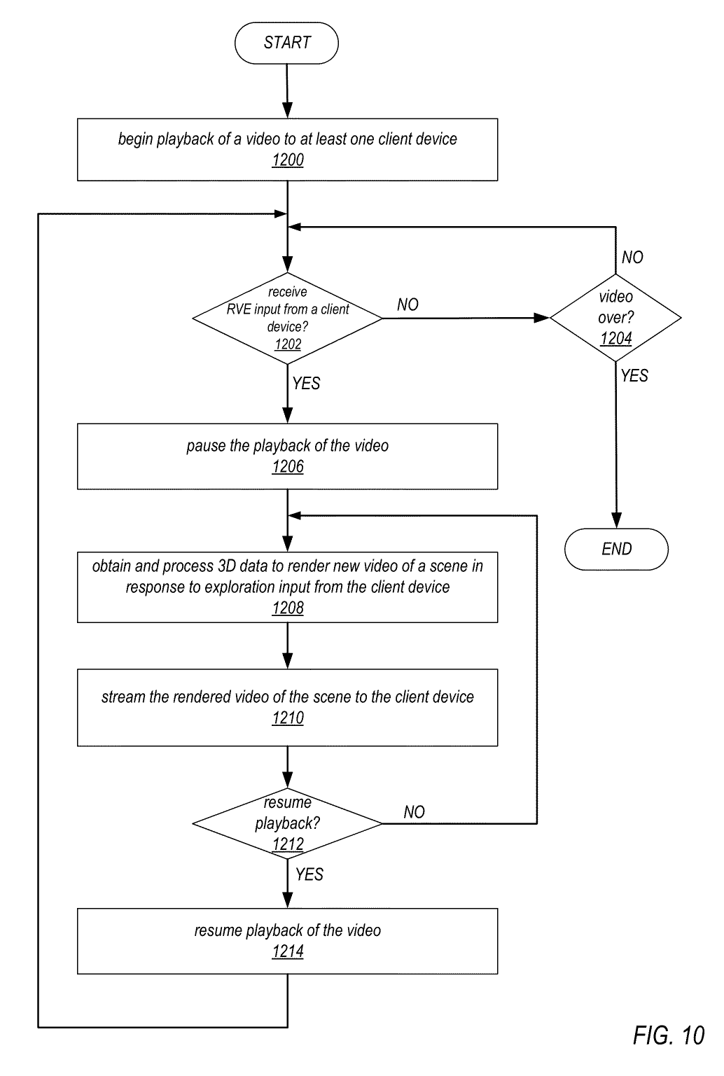

The user interactions 122 for which the interaction data 142 is obtained or collected may, for example, include interactions exploring, manipulating, and/or modifying video content within 2D or 3D modeled worlds as described herein, for example according to methods as illustrated in FIGS. 10 through 13. The user interactions 122 may include, but are not limited to, interactions navigating through, exploring, and viewing different parts of a modeled world and interactions viewing, exploring, manipulating, and/or modifying rendered objects or other video content within the modeled world.

The interaction data 142 for a particular user's interactions 122 with video content that may be collected or otherwise obtained from the RVE system 100 may include, but is not limited to, identity information for the user, what scene(s) within a video 112 a particular user chooses to explore, what parts of the modeled world(s) from the scene(s) in the video 112 the user views or navigates through, what video content (rendered objects, etc.) the user views within a modeled world, what video content (e.g., rendered objects) the user manipulates or modifies, how the user manipulates or modifies the video content, as well as timestamps or other temporal information that may, for example, be used to determine how long a user spends in relation to particular video content or in a particular activity, location, or orientation. In some embodiments, the interaction data 142 may include other data or metadata regarding the user's interactions, for example metadata related to identity, location, network address, and capabilities of the particular RVE client 120 and/or client device associated with the user.

In some embodiments, to provide targeted content to users, the interaction analysis module 140 may analyze the information in interaction data 142 to generate analysis data 144 that may, for example, include indications of correlations between users and video content, and may provide the analysis data 144 to one or more video processing modules 102, for example graphics processing module(s) of the RVE system 100. The RVE system 100 may, for example, use the analysis data 144 in rendering new video content targeted at users or groups based at least in part on the analysis data 144.

As shown in FIG. 1, in some embodiments, at least some analysis data 144 may be provided directly to video processing module(s) 102. This may allow the video processing module(s) 102 to dynamically render new video content targeted to a user based at least in part on analysis of the user's interactions 122 with the video content currently being streamed to the user's RVE client 120. In other words, while the user is exploring a modeled world of a scene, the user's interactions 122 with video content in the modeled world may be analyzed and used to dynamically modify, add, or adapt new video content being rendered for the scene according to real- or near-real-time analysis of the user's interactions 122.

As shown in FIG. 1, in some embodiments, instead of or in addition to providing analysis data 144 directly to video processing module(s) 102, at least some analysis data 144 may be written or stored to one or more data sources 110. For example, in some embodiments, a data source 110 may store user information such as user account and profile information. In some embodiments, information such as preferences, viewing history, shopping history, sex, age, location, and other demographic and historical information may be collected for or from users of the RVE system 100. This information may be used to generate and maintain user profiles, which may for example be stored to a data source 110 accessible to RVE system 100. In some embodiments, the analysis data 144 generated from analysis of a user's interactions 122 with video content in one or more videos 112 may be used to create, update or add to a user's profile. In some embodiments, the user profiles may be accessed according to identities of the users(s) when beginning, or during, the replay of a video 112, and in some embodiments may be used to dynamically and differently select and render new video content for one or more scenes that is targeted at particular users or groups of users according to their respective profiles. Thus, in some embodiments, video 112 streamed to an RVE client 120 may be modified by video processing module(s) 102 to include new video content rendered from graphics data 114 that is selected for and targeted at a particular user based at least in part on analysis of the user's interactions 122 with video content in one or more previously viewed videos 112.

In some embodiments, the interaction analysis module 140 may provide at least some analysis data 144 to one or more external systems 130, for example to one or more online merchants, or to one or more online game systems. An external system 130 such as an online merchant may, for example, use the analysis data 144 in providing content or information targeted at particular users or groups of users based at least in part on the correlations indicated in the analysis data 144. For example, an online merchant may use the analysis data 144 to provide advertising or recommendations for products or services targeted at particular customers or potential customers via one or more communications channels, for example via web pages of the merchant's web site, email, print, broadcast, or social media channels. As another example, an online game system may use the analysis data 144 to provide game content targeted at particular users or players based at least in part on analysis data 144 generated from the users' interactions with video content via the RVE system 100.

In some embodiments, the interaction analysis module 140 may obtain or access client information 132 from one or more sources. The sources may include, but are not limited to, the RVE system 100 and/or one or more external systems 130 such as an online merchant. The client information 132 may, for example, include client identity and/or profile information. Client identity information may, for example, include one or more of names, telephone numbers, email addresses, account identifiers, street addresses, mailing addresses, social media accounts, and so on. Client profile information may, for example, include preferences, historical information (e.g., purchasing history, viewing history, shopping history, browsing history, etc.), and various demographic information (e.g., sex, age, location, profession, etc.)

In some embodiments, before, during or after analysis of the interaction data 142 by the interaction analysis module 140, the client information 132 may be correlated with the interaction data 142 to associate particular users' interactions 122 with video content with the particular users' client information 132. In some embodiments, this association of client information 132 with interaction data 142 may be indicated by or included in the analysis data 144 provided to the RVE system and/or to external system(s) 130.

In some embodiments, the client information 132 associated with the interaction data 142 may be used by the RVE system 100 along with the interaction data 142 in selecting and rendering new video content targeted at particular users or groups. In some embodiments, the client information 132 associated with the interaction data 142 may be used by one or more external systems 130 in selecting and providing targeted content or information to users or groups. For example, the client information 132 may provide user profile information (e.g., purchasing history, demographics, etc.) that may be used by one or more external systems 130 such as online merchants in determining or selecting targeted information, recommendations, or advertising for customers or potential customers based at least in part on the interaction analysis data 144. The following provides non-limiting examples of applications for the client information 132 associated with interaction data 142.

For example, analysis of the interaction data 142 may determine correlations between particular video content and particular users, and the client information 132 associated with the interaction data 142 for the users may be used to determine other preferences of the users that may be used in selecting targeted content or information for the users. As another example, the client information 132 associated with the interaction data 142 for a user may be used to determine one or more products that the user has previously purchased, and this purchasing history for the user may be used in selecting and providing targeted content or information for the users.

As another example, a user's purchasing history as indicated in the client information 132 may indicate that the user already owns a particular product that the analysis data 144 correlates with the user. Thus, instead of advertising the product to the user, accessories or options for the product may be advertised to the user.

As another example, the client information 132 associated with the interaction data 142 may be used to group the users into demographic or purchasing groups, and preferences of particular users for particular content based on analysis of the interaction data 142 may be extended to the groups and used in providing content or information to the groups. As another example, preferences of demographic or purchasing groups of users for particular content may be determined from analysis of the interaction data 142 and extended to other users that are determined to be in the groups according to the client information 132, and used in providing targeted content or information to the other users.

In some embodiments, the client information 132 associated with the interaction data 142 in the analyses data 144 may instead or also provide user identity and addressing information (e.g., names, email addresses, account identifiers, street addresses, social media identities, etc.) that may be used by one or more external systems 130 such as online merchants to direct or address targeted information or advertising to customers or potential customers based at least in part on the interaction analysis data 144.

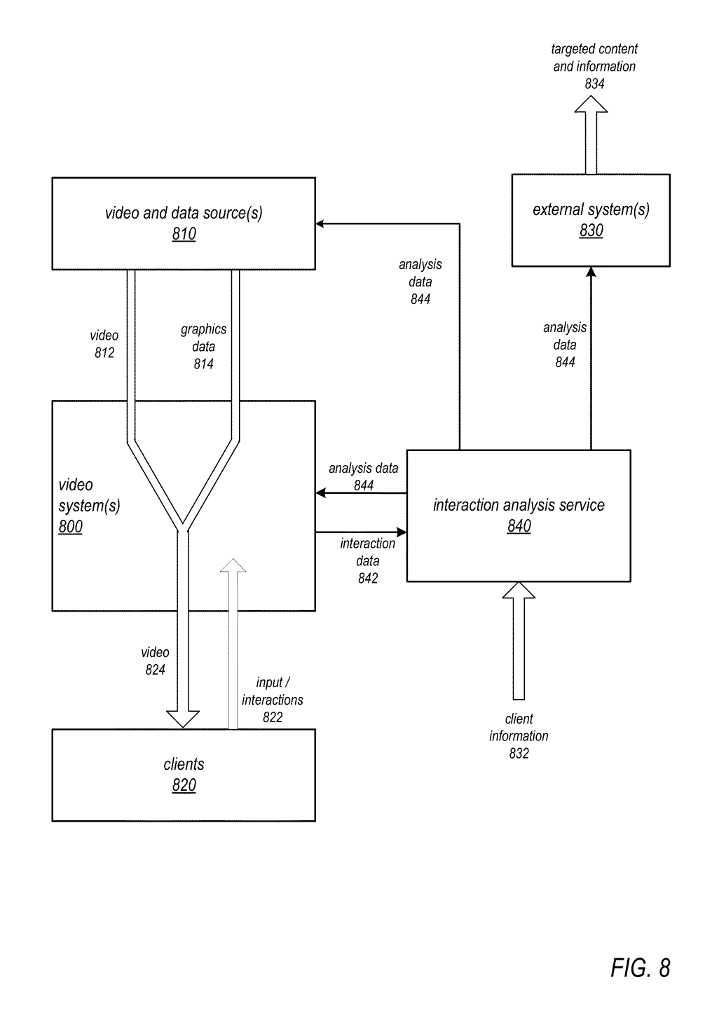

While FIG. 1 shows the interaction analysis module 140 as a component of the RVE system 100, in some embodiments, the interaction analysis module 140 may be implemented externally to the RVE system 100, for example as an interaction analysis service 800 as illustrated in FIG. 8.

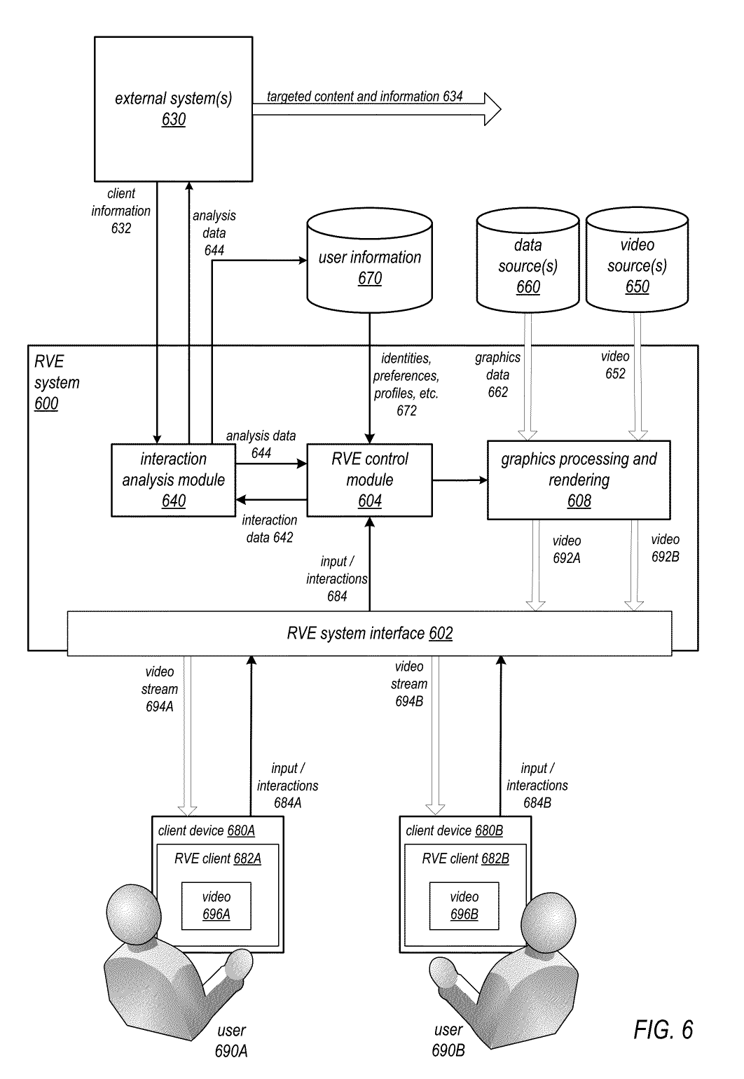

FIG. 2 is a high-level flowchart of a method for analyzing user interactions with video content and providing targeted content or information based at least in part on the analysis, according to at least some embodiments. The method of FIG. 2 may, for example, be implemented in a real-time video exploration (RVE) system, for example as illustrated in FIG. 1 or 6.

As indicated at 200 of FIG. 2, an RVE system may receive input from one or more client devices indicating user interactions with video content. The user interactions may, for example, include interactions exploring, manipulating, and/or modifying video content within 2D or 3D modeled worlds as described herein, for example according to the methods as illustrated in FIGS. 10 through 13. As indicated at 202 of FIG. 2, the RVE system may render and send new video content to the client device(s) based at least in part on the user interactions with the video content, for example according to the methods as illustrated in FIGS. 10 through 13.

As indicated at 204 of FIG. 2, the user interactions with the video content may be analyzed to determine correlations between particular users and/or groups of users and particular video content. In some embodiments, an interaction analysis module may collect or otherwise obtain data describing the user interactions from the RVE system. In some embodiments, the interaction analysis module may be a component of the RVE system. However, in some embodiments, the interaction analysis module may be implemented externally to the RVE system, for example as an interaction analysis service.

The collected interaction data may include, but is not limited to, identity information for users, information indicating particular scenes in videos and parts of modeled worlds from the scenes that the users view or navigate through, information indicating what video content (rendered objects, etc.) that users view within a modeled world, information indicating what video content (e.g., rendered objects) the users manipulate or modify, and information indicating how the users manipulate or modify the video content. In some embodiments, the interaction data may include other information such as timestamps or other temporal information that may, for example, be used to determine how long the users spend in relation to particular video content or particular activities, locations, or orientations.

In some embodiments, analysis of the users' interactions with the video content may involve determining from the interaction data particular content or types of content that a user or groups of users may be interested in or may seem to prefer or like. The content or types of content that may be correlated to users or groups via the analysis of the users' interactions may include any content or type of content that may be rendered in video and explored by users using an RVE system as described herein. For example, the content or type of content may include one or more of, but is not limited to, types of products and devices (e.g., vehicles, clothes, appliances, smartphones, pad devices, computers, etc.); particular brands, makes, models, etc. of various products or devices; places (e.g., cities, resorts, restaurants, attractions, sports stadiums, gardens, etc.); people (e.g., fictional characters, actors, historical figures, sports figures, artists, musicians, etc.); activities (e.g., cycling, racing, cooking, dining out, fishing, baseball, etc.); sports teams; genres, types, or particular works of art, literature, music, and so on; and types of animals or pets (wildlife in general, birds, horses, cats, dogs, reptiles, etc.). Note that these are all given by way of example, and are not intended to be limiting.

The following provides several examples of analyzing user interactions with various video content to determine correlations between users or groups and particular content or types of content. Note that these examples are not intended to be limiting.

As an example, the interaction data may be analyzed to determine that a particular user viewed, selected, explored, manipulated, and/or modified a particular object or type of object, and analysis data may be generated for the user that indicate that the user appears to be interested in that object or type of object. For example, the object may be a particular make and model of an automobile, and the user's interactions with that automobile may indicate that the user appears to be interested in that make and model. As another example, the interactions of the user with video content in one or more scenes in one or more videos may indicate general interest in a type of object, such as automobiles in general, or automobiles made by a particular manufacturer, or automobiles of particular types such as SUVs or sports cars, or automobiles of a particular era such as 1960's muscle cars. These various interests may be recorded in the analysis data for the user.

As another example, the interaction data may be analyzed to determine that a particular user appears to show interest in a particular character in an animated or live-action show or series, or in a particular real-life actor or actress that appears in different roles in different videos. For example, the user may pause video to view or obtain information about a particular fictional character, or to manipulate, modify, or customize a particular fictional character. This interest may be recorded in the analysis data for the user.

As another example, the interaction data may be analyzed to determine that a particular user appears to show interest in a particular location or destination. For example, a user may pause a movie to explore a 3D modeled world of a particular hotel, resort, or attraction that appears in the movie. This interest may be recorded in the analysis data for the user.

In some embodiments, the content of video that may be explored via user interactions in an RVE system may include audio content (e.g., songs, sound effects, sound tracks, etc.). In some embodiments, the interaction data may be analyzed to determine that a particular user appears to show interest in particular audio content. For example, a user may interact with video to investigate audio tracks recorded by particular artists or bands, or of particular genres. These audio interests may be recorded in the user's analysis data.

In some embodiments, the interaction data may be analyzed to determine particular content or types of content that groupings of users appear to be interested in.

The groups of users may, for example, be determined according to user profile information including but not limited to various user information (e.g., demographic information and/or historical information such as purchasing history) that is maintained by the RVE system and/or obtained from one or more other, external sources. For example, analysis of the interaction data may determine that a particular object such as a particular make and model of automobile, or a particular brand or article of clothing or accessory, that appears in video(s) may tend to be viewed, selected, explored, manipulated, and/or modified by users in a certain geographic area and/or of a certain age and sex profile (e.g., females in the northeastern U.S. in the 21-35 age group). The analysis data generated by the interaction analysis module may include information indicating these types of group interests.

As indicated at 206 of FIG. 2, targeted content or information may be provided to particular users or groups based at least in part on the determined correlations between the users or groups of users and video content. In some embodiments, the interaction analysis module may provide at least some of the analysis data to one or more systems. The systems to which analysis data may be provided may include, but are not limited to, the RVE system and/or external systems such as online merchant systems and online game systems. The one or more systems may provide content or information targeted at users or groups of users based at least in part on the determined correlations as indicated in the analysis data.

For example, analysis data generated from user interactions with video currently being streamed to one or more users may be provided to the RVE system and used by the RVE system to dynamically determine video content to be targeted at particular users or groups and inject the targeted video content into the video currently being streamed to the users. As another example, the analysis data generated from user interactions with video may be used to create or add to users' profiles for the RVE system; the users' profiles may be accessed by the RVE system and used in customizing or targeting video content when streamed to the users by the RVE system.

As another example, the analysis data generated from user interactions with video may be provided to one or more external systems such as online merchants or game systems. An external system such as an online merchant may, for example, use the analysis data in providing content or information targeted at particular users or groups of users based at least in part on the correlations indicated in the analysis data. For example, an online merchant may use the analysis data to provide advertising or recommendations for particular services, products or types of products targeted at particular customers or potential customers via one or more communications channels, for example via web pages of the merchant's web site, email, or social media channels. As another example, an online game system may use the analysis data to provide game content targeted at particular players based at least in part on analysis data generated from the users' interactions with video content via an RVE system.

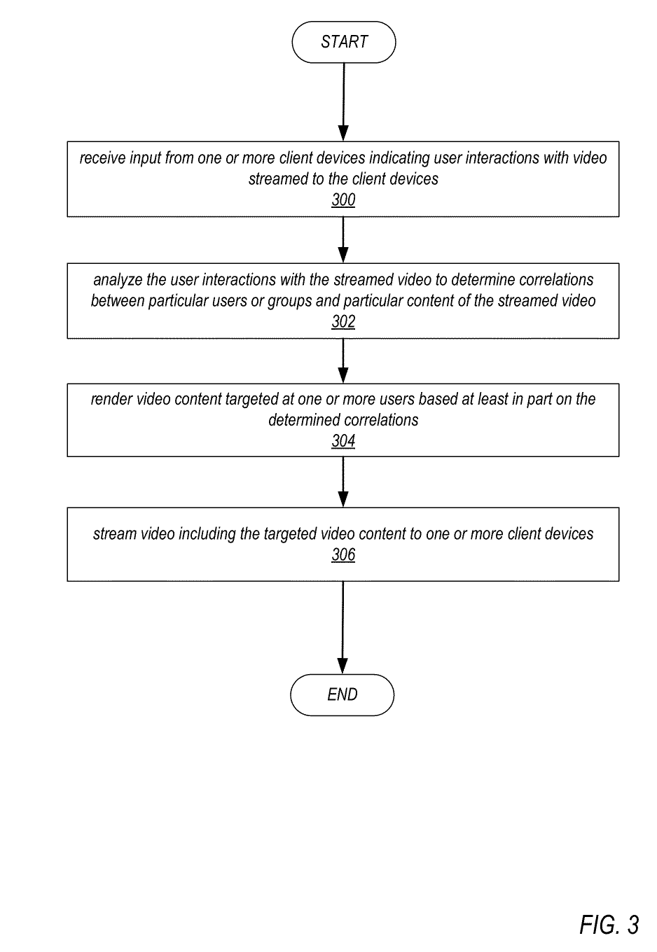

FIG. 3 is a high-level flowchart of a method for analyzing user interactions with video content and rendering and streaming new video content based at least in part on the analysis, according to at least some embodiments. The method of FIG. 3 may, for example, be implemented in a real-time video exploration (RVE) system, for example as illustrated in FIG. 1 or 6.

As indicated at 300 of FIG. 3, an RVE system may receive input from one or more client devices indicating user interactions with video streamed to the client devices. The user interactions may, for example, include interactions exploring, manipulating, and/or modifying video content within 2D or 3D modeled worlds as described herein, for example according to the methods as illustrated in FIGS. 10 through 13.

As indicated at 302 of FIG. 3, an interaction analysis module may analyze the user interactions with the streamed video to determine correlations between particular users or groups and particular content of the streamed video. In some embodiments, the interaction analysis module may collect or otherwise obtain data describing various user interactions with the streamed video content from the RVE system and analyze the collected interaction data, for example as described in reference to element 204 of FIG. 2.

As indicated at 304 of FIG. 3, the RVE system may render video content targeted at one or more users based at least in part on the determined correlations between users or groups and video content as indicated in the analysis data. The interaction analysis module may provide interaction analysis data to the RVE system. For example, in some embodiments, the interaction analysis module may provide at least some of the analysis data directly to one or more video processing modules of the RVE system. In some embodiments, instead or in addition to providing analysis data to the video processing modules of the RVE system, the interaction analysis data may be used to update users' profiles for the RVE system, and the video processing module(s) of the RVE system may access the user profiles to obtain updated interaction analysis data for respective users.

Before or during playback of a video (e.g., a movie) to one or more users, video processing module(s) of the RVE system may use the correlations indicated in the interaction analysis data provided by the interaction analysis module to determine and obtain targeted video content for particular users or groups of users; the targeted video content may, for example, be used to dynamically and differently render one or more objects or other video content in one or more scenes that are targeted at particular users or groups of users according to the correlations indicated in the interaction analysis data. As a non-limiting example, if the interaction analysis data for a particular user or group of users indicates that the user or group prefers a particular make and model of automobile, a 2D or 3D model of the particular automobile may be obtained, rendered, and inserted into video to be streamed to the user or group.

As indicated at 306 of FIG. 3, the RVE system may stream video including the targeted video content to one or more client devices associated with the targeted users. Thus, different users of the same video content (e.g., a movie) may be shown the same scenes with differently rendered, targeted objects injected into the scenes based at least in part on the users' interactions with previously streamed video content.

In at least some embodiments, the RVE system may leverage network-based computation resources and services to dynamically render new video content for the different users in real-time at least in part according to the correlations indicated in the interaction analysis data, and to deliver the newly rendered video content as video streams to respective client devices. The computational power available through the network-based computation resources may allow the RVE system to dynamically render any given scene of a video being streamed to users or groups to be modified and viewed in many different ways based at least in part on the correlations between users and groups and particular video content as indicated in the interaction analysis data. As a non-limiting example, one user may be shown an automobile of a particular make, model, color, and/or option package dynamically rendered in a scene of a pre-recorded video being played back based at least in part on analysis of users' previous interactions with video content, while another user may be shown an automobile of a different make, model, color, or option package when viewing the same scene. As another non-limiting example, one user or group may be shown a particular brand or type of personal computing device, beverage, or other product in a scene based at least in part on analysis of users' previous interactions with video content, while another user or group may be shown a different brand or type of device or beverage. In some embodiments, other video content than objects may also be dynamically rendered based at least in part on analysis of users' previous interactions with video content. For example, background, color(s), lighting, global or simulated effects, or even audio in a scene may be rendered or generated differently for different users or groups based at least in part on the users' history of interactions with video content.

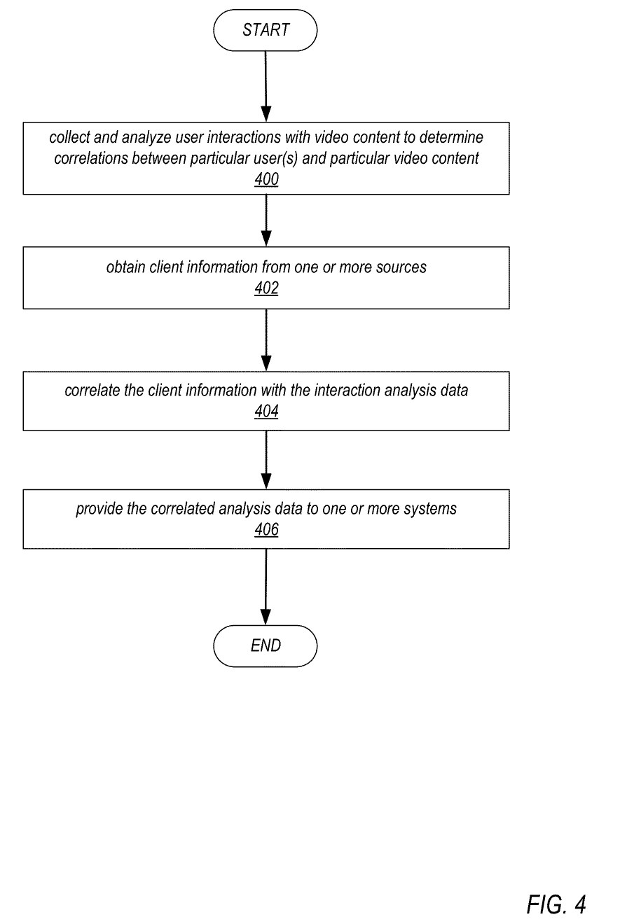

FIG. 4 is a high-level flowchart of a method for analyzing user interactions with video content and correlating the analysis data with client information obtained from one or more sources, according to at least some embodiments. The method of FIG. 4 may, for example, be implemented in a real-time video exploration (RVE) system, for example as illustrated in FIG. 1 or 6.

As indicated at 400 of FIG. 4, user interactions with video content may be collected and analyzed to determine correlations between particular user(s) and particular video content. In some embodiments, an interaction analysis module may collect or otherwise obtain data describing various user interactions with the streamed video content from the RVE system and analyze the collected interaction data, for example as described in reference to element 204 of FIG. 2.

As indicated at 402 of FIG. 4, client information may be obtained from one or more sources. The sources may include, but are not limited to, the RVE system and/or one or more external systems such as an online merchant. The client information may, for example, include client identity and/or profile information. Client identity information may, for example, include one or more of names, telephone numbers, email addresses, account identifiers, street addresses, mailing addresses, social media accounts, and so on. Client profile information may, for example, include preferences, historical information (e.g., purchasing history, viewing history, shopping history, browsing history, etc.), and various demographic information (e.g., sex, age, location, profession, etc.)

As indicated at 404 of FIG. 4, the client information may be correlated with the interaction analysis data. In some embodiments, before, during or after analysis of the interaction data by the interaction analysis module, the client information may be correlated with the interaction data to associate particular users' interactions with video content with the particular users' client information. In some embodiments, this association of client information with interaction data may be indicated or included in the analysis data provided to the RVE system and/or to one or more external systems.

As indicated at 406 of FIG. 4, the correlated analysis data may be provided to one or more systems. The systems to which analysis data may be provided may include, but are not limited to, the RVE system and/or external systems such as online merchants and online game systems. A system may provide content or information targeted at users or groups of users based at least in part on the correlated analysis data. For example, in some embodiments, the client information associated with the interaction data may be used by the RVE system along with the interaction data in selecting and rendering new video content targeted at particular users or groups. In some embodiments, the client information associated with the interaction data may be used by one or more external systems in selecting and providing targeted content or information to users or groups. For example, the client information may provide user profile information (e.g., purchasing history, demographics, etc.) that may be used by one or more external systems in determining or selecting targeted information, recommendations, or advertising for products or services for customers or potential customers based at least in part on the interaction analysis data, as well as user identity and addressing information that may be used to direct or address the targeted information, recommendations, or advertising for products or services to the customers or potential customers.

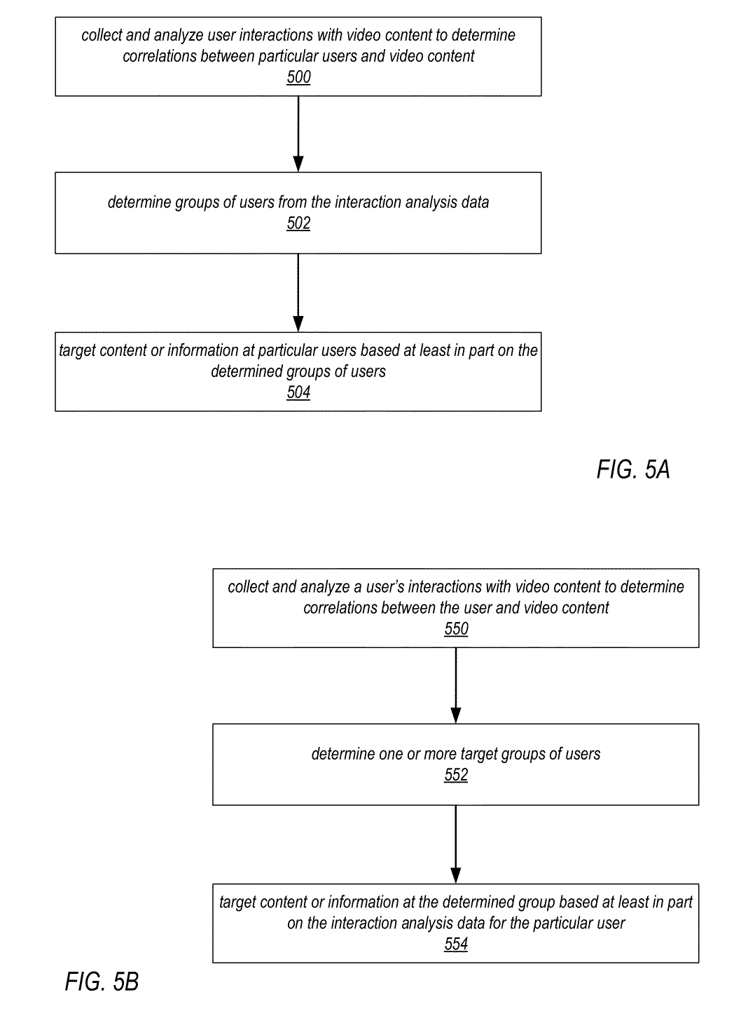

FIG. 5A is a high-level flowchart of a method for determining correlations between groups of users and video content according to analysis of user interactions with the video content and targeting content or information at particular users based at least in part on the group correlation data, according to at least some embodiments. The method of FIG. 5A may, for example, be implemented in a real-time video exploration (RVE) system, for example as illustrated in FIG. 1 or 6.

As indicated at 500 of FIG. 5A, user interactions with video content may be collected and analyzed to determine correlations between particular users and video content. In some embodiments, an interaction analysis module may collect or otherwise obtain data describing various user interactions with the streamed video content from the RVE system and analyze the collected interaction data, for example as described in reference to element 204 of FIG. 2.

As indicated at 502 of FIG. 5A, groups of users may be determined from the interaction analysis data. For example, in some embodiments, the interaction analysis data may be further analyzed to determine groupings of users that showed some degree of interest in particular video content according to their interactions with the video content, for example a particular scene or particular object or character within the scene. In some embodiments, the groupings of users may be further refined, for example according to client information and/or user profiles obtained from one or more sources, to determine refined groupings based on purchasing history, demographics, preferences, and so on. As another example, groupings of users may first be formed based on purchasing history, demographics, preferences, and so on, and then refined according to correlations between users in the groups and particular video content as determined by analysis of the users' interactions with video content. In some embodiments, group profiles may be maintained by an RVE system or another system that each includes information defining a respective grouping of users.

As indicated at 504 of FIG. 5A, content or information may be targeted at particular users based at least in part on the determined groupings of users. For example, an RVE system as illustrated in FIG. 1 may compare a profile of a user (purchasing history, demographics, preferences, etc.) to one or more group profiles to determine one or more groupings that the user may fit in (or not fit in), and may select, render, and insert targeted video content into video being streamed to the user at least in part on the determined grouping(s).

FIG. 5B is a high-level flowchart of a method for targeting content or information at groups at least in part according to analysis of a particular user's interactions with video content, according to at least some embodiments. The method of FIG. 5B may, for example, be implemented in a real-time video exploration (RVE) system, for example as illustrated in FIG. 1 or 6.

As indicated at 550 of FIG. 5B, a user's interactions with video content may be collected and analyzed to determine correlations between the particular user and video content. In some embodiments, an interaction analysis module may collect or otherwise obtain data describing the user's various user interactions with streamed video content from the RVE system and analyze the collected interaction data, for example as described in reference to element 204 of FIG. 2, to generate interaction analysis data based on the particular user's interactions.

As indicated at 552 of FIG. 5B, one or more target groups of users may be determined for the interaction analysis data. For example, in some embodiments, a target group may be one or more other players of a game or viewers of a video that the particular user is interacting with. As another example, in some embodiments, group profiles may be maintained by an RVE system or another system that each includes information defining a respective grouping of users, and one or more groups that the particular user is a member of may be determined as target groups. As another example, interaction analysis data may be collected and analyzed for multiple users to determine groupings of users that may share interests similar to those of the particular user. In some embodiments, groupings of users that may share interests or characteristics similar to those of the particular user may be determined according to client information and/or user profiles obtained from one or more sources. The client information may, for example, include purchasing history, demographics, preferences, and so on. Note that a group may include one, two, or more users.

As indicated at 554 of FIG. 5B, content or information may be targeted at the determined group(s) of users based at least in part on the generated interaction analysis data based on the particular user's interactions. For example, an RVE system as illustrated in FIG. 1 may select, render, and insert targeted video content into video being streamed to one or more users in a group at least in part based on the particular user's interests in particular video content as indicated in the interaction analysis data. As another example, an external systems 130 as illustrated in FIG. 1 may provide content or information targeted at a group of users on the particular user's interests in particular video content as indicated in the interaction analysis data.

FIG. 6 is a block diagram illustrating an example real-time video exploration (RVE) system 600 in an RVE environment in which user interactions with video content are analyzed to determine correlations between users and content, according to at least some embodiments. In some embodiments of an RVE system 600, users 690 can explore, manipulate, and/or modify video content in 2D or 3D modeled worlds rendered in real-time during playback of pre-recorded video 652, for example according to methods as illustrated in FIGS. 10 through 13. In some embodiments of an

RVE system 600, video 652 being played back to client devices 680 may be replaced with dynamically rendered video 692 content specifically targeted at users 690 associated with the respective client devices 680 according to user information including but not limited to user profile information. FIG. 14 illustrates an example network environment in which network-based computation resources may be leveraged to provide real-time, low-latency rendering and streaming of video content that may be used to implement an RVE system 600. FIG. 16 illustrates an example provider network environment in which embodiments of an RVE system 600 may be implemented. FIG. 17 is a block diagram illustrating an example computer system that may be used in embodiments of an RVE system 600.

In at least some embodiments, an RVE environment as illustrated in FIG. 6 may include an RVE system 600 and one or more client devices 680. The RVE system 600 may have access to one or more stores or other sources of pre-rendered, pre-recorded video, shown as video source(s) 650. The video may include one or more of, but is not limited to movies, shorts, cartoons, commercials, and television and cable programs. The video available from video source(s) 650 may, for example, include fully rendered, animated video content, as well as partially rendered video content that involves filming live action using green- or blue-screen technology and adding background and/or other content or effects using one or more computer graphics techniques.

In some embodiments, in addition to sequences of video frames, a video may include other data such as audio tracks, video metadata, and frame components. For example, in some embodiments, each video frame may have or may correspond to a frame tag that includes information about the frame. Video metadata may include, but is not limited to, time stamps for frames and scene information. The scene information may include information about objects and other video content in the scene that may, for example, be used in determining video content in a scene that may be dynamically replaced with graphics data 662. In some embodiments, a digital video frame may be composed of multiple layers, for example one or more alpha mask layers corresponding to objects or other content in the scene, that are composited together to produce the frame. In some embodiments, these layers may be used in inserting the graphics data 662 into the scene. For example, an alpha mask corresponding to a particular object in a scene may be identified and used to replace the default or pre-rendered object in the scene with a different object rendered at least in part according to graphics data 662 retrieved from a data source 660.

In some embodiments, the RVE system 600 may have access to one or more stores or other sources of data and information including but not limited to 2D and 3D graphics data, shown as data source(s) 660. In some embodiments, data source(s) 660 may include graphics data (e.g., 2D and/or 3D models of objects) that was used in generating and rendering scenes for at least some of the pre-recorded video available from video sources 650. In some embodiments, data source(s) 660 may also include other graphics data, for example graphics data from one or more external system(s) 630, user-generated graphics data, graphics data from games or other applications, and so on. Data source(s) 660 may also store or otherwise provide other data and information including but not limited to data and information about users 690.

In some embodiments, the RVE system 600 may maintain and/or access stores or other sources of user information 670. Non-limiting examples of user information 670 may include RVE system 600 and/or external system 630 registration or account information, client device 680 information, name, account number, contact information, billing information, and security information. In some embodiments, user profile information (e.g., preferences, viewing history, shopping history, sex, age, location, and other demographic and historical information) may be collected for or from users of the RVE system 600, or may be accessed from other information sources or providers including but not limited to external system(s) 630. This user profile information may be used to generate and maintain user profiles for respective users 690; the user profiles may be stored as or in user information 670. The user profiles may be accessed from user information 670 sources, for example according to identities of the user(s) 690, when beginning replay of, or during the replay of, video(s) 652 from a video source 650, and may be used to dynamically and differently render one or more objects or other video content in one or more scenes using graphics data 662 obtained from data source(s) 660 so that the scene(s) are targeted at particular users 690 according to their respective user profiles.

In some embodiments, the RVE system 600 may include an RVE system interface 602, an RVE control module 604, and graphics processing and rendering 608 module(s). In some embodiments, graphics processing and rendering may be implemented as two or more separate components or modules. In some embodiments, RVE system interface 602 may include one or more application programming interfaces (APIs) for receiving input from and sending or streaming output to RVE client(s) 682 on client device(s) 680. In some embodiments, in response to viewer 690 selection of a video 652 for playback, the graphics processing and rendering 608 module may obtain pre-rendered, pre-recorded video 652 from a video source 650, process the video 652 as necessary to generate output video 692, and stream the video 694 to the respective client device 680 via RVE system interface 602. Alternatively, in some embodiments, the RVE system 600 may begin playback of a pre-recorded video 654, for example according to a program schedule, and one or more user 690 may choose to view the playback of the video 654 via respective client devices 680.

In some embodiments, for a given user 690, graphics processing and rendering 608 module(s) may obtain graphics data 662 from one or more data sources 660, for example according to the user's profile information, generate a modeled world for one or more scenes in a video 652 being viewed by the user 690 via a client device 680 according to the graphics data 662, render 2D representations of the modeled world to generate output video 692, and send the real-time rendered video to the respective client device 680 as a video stream 694 via RVE system interface 602.

In some embodiments, during an RVE system 600 event in which a user 690 interacts with video 696 via input to an RVE client 682 on a client device 680 to explore, manipulate, and/or modify video content, graphics processing and rendering 608 module may obtain graphics data 662 from one or more data sources 660 according to the interactions 684, generate a modeled world for the scene at least in part according to the graphics data 662 and user interactions 684, render 2D representations of the 3D modeled world to generate output video 692, and stream the real-time rendered video to the respective client device 680 as a video stream 694 via RVE system interface 602.

In some embodiments, the RVE system 600 may include an RVE control module 604 that may receive input and interactions 684 from an RVE client 682 on a respective client device 680 via RVE system interface 602, processes the input 684, and direct operations of graphics processing and rendering 608 module accordingly. In at least some embodiments, the input and interactions 684 may be received according to an API provided by RVE system interface 602. In at least some embodiments, RVE control module 604 may also retrieve user profile, preferences, and/or other user information from a user information 670 source and direct graphics processing and rendering 608 module in selecting graphics data 662 and rendering targeted video 692 content for the user(s) 690 at least in part according to the user's respective profiles and/or preferences.

In some embodiments, the RVE system 600 may implement interaction analysis methods via at least one interaction analysis module 640 to, for example, collect data 642 about user interactions 684 with video content within the RVE system 600, analyze the collected data 642 to determine correlations between users 690 and video content, and provide content or information targeted at particular users or groups of users based at least in part on the determined correlations. The RVE system 600 may, for example, implement embodiments of one or more of the interactive analysis methods as illustrated in FIGS. 2 through 5. The user interactions 684 for which the interaction data 642 is obtained or collected may, for example, include interactions exploring, manipulating, and/or modifying video content within 2D or 3D modeled worlds as described herein, for example according to methods as illustrated in FIGS. 10 through 13. The user interactions 684 may include, but are not limited to, interactions navigating through, exploring, and viewing different parts of a modeled world and interactions viewing, exploring, manipulating, and/or modifying rendered objects or other video content within the modeled world.

In some embodiments, interaction analysis module 640 may obtain interaction data 642 from RVE control module 604, as shown in FIG. 6. While not shown in FIG. 6, in some embodiments, interaction analysis module 640 may instead or in addition obtain interaction data 642 directly from RVE system interface 602. In some embodiments, the interaction data 642 may include, but is not limited to, identity information for users 690, information indicating particular scenes in videos 652 and parts of modeled worlds from the scenes that the users 690 view or navigate through, information indicating what video content (rendered objects, etc.) that users 690 view within a modeled world, information indicating what video content (e.g., rendered objects) the users 690 manipulate or modify, and information indicating how the users manipulate or modify the video content. In some embodiments, the interaction data 652 may include other information such as timestamps or other temporal information that may, for example, be used to determine how long the users 690 spend in relation to particular video content or particular activities, locations, or orientations. In some embodiments, the interaction data 642 may include other data or metadata regarding the users' interactions, for example metadata related to identity, location, network address, and capabilities of particular RVE clients 682 and/or client devices 680 associated with the users 690.

In some embodiments, to provide targeted content to users 690, the interaction analysis module 640 may analyze the information in interaction data 642 to generate analysis data 644 that may, for example, include indications of correlations between users 690 and video content, and may provide the analysis data 644 to the graphics processing and rendering 608 module(s) of the RVE system 600. The graphics processing and rendering 608 module(s) may use the analysis data 644 in rendering new video content 692 at least in part from graphics data 662 targeted at users 690 or groups based at least in part on the analysis data 644.

As shown in FIG. 6, in some embodiments, at least some analysis data 644 may be provided directly to graphics processing and rendering 608 module(s) via RVE control module 604. This may allow the graphics processing and rendering 608 module(s) to dynamically render new video content targeted to a user 690 based at least in part on analysis of the user's interactions 684 with the video content currently being streamed to the user's RVE client 682. In other words, while the user 690 is exploring a modeled world of a scene, the user's interactions 684 with video content in the modeled world may be analyzed and used to dynamically modify, add, or adapt new video content being rendered for the scene according to real- or near-real-time analysis of the user's interactions 684.

As shown in FIG. 6, in some embodiments, instead of or in addition to providing analysis data 644 directly to directly to graphics processing and rendering 608 module(s) via RVE control module 604, in some embodiments, analysis data 644 generated from analysis of users' interactions 684 with video content may be used to create, update, or add to the user profiles maintained as or in user information 670. The user profiles may be accessed 672 from a user information 670 source, for example according to identities of the user(s) 690, when beginning replay of, or during the replay of, video(s) 652 from a video source 650, and may be used to dynamically and differently render one or more objects or other video content in one or more scenes using graphics data 662 obtained from data source(s) 660 so that the scene(s) are targeted at particular users 690 according to their respective user profiles. Thus, video 652 being streamed to an RVE client 682 may be modified by the RVE system 600 to generate video 692 that includes targeted video content rendered from graphics data 662 that is selected for and targeted at particular users based at least in part on analysis of the users' interactions 684 with video content from previously viewed video 652.

In some embodiments, the interaction analysis module 640 may provide at least some analysis data 644 to one or more external systems 630, for example to one or more online merchants or online game systems. An external system 630 such as an online merchant may, for example, use the analysis data 644 in providing information 634 targeted at particular users 690 or groups of users based at least in part on the correlations indicated in the analysis data 644. For example, an online merchant may use the analysis data 644 to provide advertising or recommendations for products or services targeted at particular customers or potential customers via one or more channels, for example via web pages of the merchant's web site, email, or social media channels. As another example, in some embodiments, an external system 630 may use the analysis data 644 to determine or create targeted graphics data 662, and may provide targeted graphics data 662 (e.g., 2D or 3D models of particular products) to data source(s) 660 for inclusion in video 692 targeted at particular users 690 or groups of users 690. As another example, an online game system may use the analysis data 644 to provide game content targeted at particular users or players or groups of players based at least in part on analysis data 644 generated from the users' interactions with video content via the RVE system 600.

In some embodiments, the interaction analysis module 640 may obtain or access client information 632 from one or more external systems 630 such as an online merchant. The client information 632 may, for example, include client identity and/or profile information. Client identity information may, for example, include one or more of names, telephone numbers, email addresses, account identifiers, street addresses, mailing addresses, and so on. Client profile information may, for example, include preferences, historical information (e.g., purchasing history, viewing history, shopping history, browsing history, etc.), and various demographic information (e.g., sex, age, location, profession, etc.)

In some embodiments, before, during or after analysis of the interaction data 642 by the interaction analysis module 640, the client information 632 may be correlated with the interaction data 642 to associate particular users' interactions 684 with video content with the particular users' client information 632. In some embodiments, this association of client information 632 with interaction data 642 may be indicated or included in the analysis data 644. In some embodiments, the client information 632 associated with the interaction data 642 in the analyses data 644 may be used by the RVE system 600, for example in selecting and rendering new video content targeted at users 690 or groups based at least in part on user profile information (e.g., purchasing history, demographics, etc.) indicated by the client information 632. In some embodiments, the client information 632 associated with the interaction data 642 in the analyses data 644 may provide user profile information (e.g., purchasing history, demographics, etc.) that may be used by one or more external systems 630 such as online merchants in directing targeted information or advertising 634 for products or services to customers or potential customers based at least in part on the interaction analysis data 644. In some embodiments, the client information 632 associated with the interaction data 642 in the analyses data 644 may instead or also provide user identity information (e.g., email addresses, account identifiers, street addresses, etc.) that may be used by one or more external systems 630 such as online merchants to direct targeted information or advertising for products or services to customers or potential customers based at least in part on the interaction analysis data 644.

In at least some embodiments, RVE system 600 may be implemented by or on one or more computing devices, for example one or more server devices or host devices, that implement at least modules or components 602, 604, 608, and 640, and may also include one or more other devices including but not limited to storage devices that, for example, store pre-recorded video, graphics data, and/or other data and information that may be used by RVE system 600. FIG. 17 illustrates an example computer system that may be used in some embodiments of an RVE system 600. In at least some embodiments, the computing devices and storage devices may be implemented as network-based computation and storage resources, for example as illustrated in FIG. 14.

However, in some embodiments, functionality and components of RVE system 600 may be implemented at least in part on one or more of the client devices 680. For example, in some embodiments, at least some client devices 680 may include a rendering component or module that may perform at least some rendering of video data 694 streamed to the client devices 680 from RVE system 600. Further, in some embodiments, instead of an RVE system implemented according to a client-server model or variation thereof in which one or more devices such as servers host most or all of the functionality of the RVE system, an RVE system may be implemented according to a distributed or peer-to-peer architecture. For example, in a peer-to-peer architecture, at least some of the functionality and components of an RVE system 600 as shown in FIG. 6 may be distributed among one, two, or more devices 680 that collectively participate in a peer-to-peer relationship to implement and perform real-time video targeting methods as described herein.

While FIG. 6 shows two client devices 680 and clients 690 interacting with RVE system 600, in at least some embodiments RVE system 600 may support any number of client devices 680. For example, in at least some embodiments, the RVE system 600 may be a network-based video playback system that leverages network-based computation and storage resources to support tens, hundreds, thousands, or even more client devices 680, with many videos being played back by different viewers 690 via different client devices 680 at the same time. In at least some embodiments, the RVE system 600 may be implemented according to a service provider's provider network technology and environment, for example as illustrated in FIGS. 14 and 16, that may implement one or more services that can be leveraged to dynamically and flexibly provide network-based computation and/or storage resources to support fluctuations in demand from the user base. In at least some embodiments, to support increased demand, additional computation and/or storage resources to implement additional instances of one or more of the modules of the RVE system 600 (e.g., graphics processing and rendering module(s) 608, RVE control 604 module(s), interaction analysis module(s) 640, etc.) or other components not shown (e.g., load balancers, routers, etc.) may be allocated, configured, “spun up”, and brought on line. When demand decreases, resources that are no longer needed can be “spun down” and deallocated. Thus, an entity that implements an RVE system 600 on a service provider's provider network environment, for example as illustrated in FIGS. 14 and 16, may only have to pay for use of resources that are needed, and only when they are needed.

In at least some embodiments, an RVE client system may include a client device 680 that implements an RVE client 682. The RVE client 682 may implement an RVE client interface (not shown) via which the RVE client 682 may communicate with an RVE system interface 602 of RVE system 600, for example according to an API or APIs provided by RVE system interface 602. The RVE client 682 may receive video stream 694 input from RVE system 600 via RVE client interface 684 and send the video 696 to a display component of client device 680 to be displayed for viewing. The RVE client 682 may also receive input from the viewer 690, for example input interacting with content in one or more scenes of video 696 to explore, manipulate, and/or modify video content, and communicate at least some of the input to RVE system 600 via the RVE client interface.

A client device 680 may be any of a variety of devices (or combinations of devices) that can receive, process, and display video input according to an RVE client 682 implementation on the device. A client device 680 may include, but is not limited to, input and output components and software via which viewers 690 can interface with the RVE system 600 to play back and explore video in real-time using the various RVE system 600 methods as described herein. A client device 680 may implement an operating system (OS) platform that is compatible with the device 680. The RVE client 682 and RVE client interface on a particular client device 680 may be tailored to support the configuration and capabilities of the particular device 680 and the OS platform of the device 680. Examples of client devices 680 may include, but are not limited to, set-top boxes coupled to video monitors or televisions, cable boxes, desktop computer systems, laptop/notebook computer systems, pad/tablet devices, smartphone devices, game consoles, and handheld or wearable video viewing devices. Wearable devices may include, but are not limited to, glasses or goggles and “watches” or the like that are wearable on the wrist, arm, or elsewhere.

In addition to the ability to receive and display video 696, a client device 680 may include one or more integrated or external control devices and/or interfaces that may implement RVE controls (not shown). Examples of control devices that may be used include, but are not limited to, conventional cursor control devices such as keyboards and mice, touch-enabled display screens or pads, game controllers, remote control units or “remotes” such as those that commonly come with consumer devices, and “universal” remote control devices that can be programmed to operate with different consumer devices. In addition, some implementations may include voice-activated interface and control technology.

Note that, in FIGS. 1 through 6 and elsewhere in this document, the terms “user”, “viewer”, or “consumer” are generally used to refer to an actual human that participates in an RVE system 600 environment via a client device 680 to play back, explore, manipulate, and/or modify video content as described herein, while the term “client” (as in “client device” and “RVE client”) is generally used to refer to a hardware and/or software interface via which the user or viewer interacts with the RVE system 600 to play back, explore, manipulate, and/or modify video content as described herein.

As a non-limiting example of operations of an RVE system 600 as illustrated in FIG. 6, RVE control module 604 may direct graphics processing and rendering 608 module to begin playback of a video 652 or portion thereof from a video source 650 to one or more client devices 680, for example in response to input received from a client device 680 or according to a program schedule. During playback of the video 652 to the client devices 680, RVE control module 604 may determine identity of users 690 (e.g., users 690A and 690B), access the users' profiles and preferences from viewer information 670 according to their identity, and direct graphics processing and rendering 608 module to render particular content (e.g., particular objects) in one or more scenes to target particular users 690 (e.g., users 690A and 690B), at least in part according to the users' profiles and/or preferences accessed from user information 670. In response, the graphics processing and rendering 608 module may obtain graphics data 662 from data source(s) 660, and use the graphics data 662 in rendering video 692A and 692B targeted at viewers 690A and 690B, respectively. RVE system interface 602 may stream the rendered videos 692A and 692B to the respective client devices 680A and 680B as video streams 694A and 694B.

In some embodiments, preferences and/or profiles may be maintained in user information 670 for groups of users, for example families or roommates, and RVE control module 604 may direct graphics processing and rendering 608 module to obtain graphics data 662 targeted at a particular group to generate and render video 692 targeted at the particular groups according to the group's preferences and/or profile.

Note that, while FIG. 6 shows two client devices 680 and two viewers 690, the RVE system 600 may be used to generate and render targeted video content to tens, hundreds, thousands, or more client devices 680 and viewers 690 simultaneously. In at least some embodiments, the RVE system 600 may leverage network-based computation resources and services (e.g., a streaming service) to determine user profiles and preferences, responsively obtain graphics data, and generate or update targeted models from the graphics data according to the user profiles or preferences, render new, targeted video content 692 from the models, and deliver the newly rendered, targeted video content 692 to multiple client devices 680 in real-time or near-real-time as targeted video streams 694. The computational power available through the network-based computation resources, as well as the video streaming capabilities provided through a streaming protocol, may allow the RVE system 600 to dynamically provide personalized video content to many different users 690 on many different client devices 680 in real time.

### Game System Implementations

While embodiments of the interaction analysis methods and modules are generally described above in reference to real-time video exploration (RVE) systems in which users can interactively explore content of pre-recorded video such as movies and television show, embodiments may also be applied within gaming environments to analyze game players' interactions within game universes to determine correlations between the players and game video content and to provide content or information targeted at particular users or groups of users based at least in part on the analysis. Referring to FIG. 1, RVE system 100 may be a game system, video processing module(s) 102 may be or may include a game engine, RVE client(s) may be game clients, and users may be players or game players.

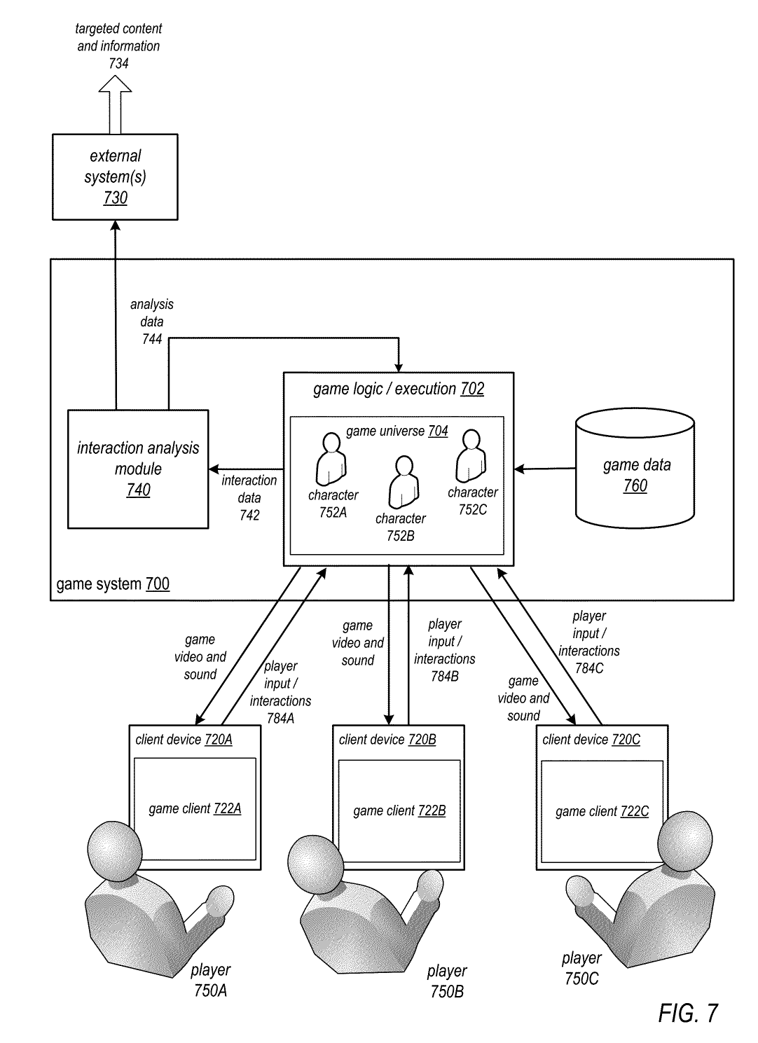

FIG. 7 is a block diagram that graphically illustrates a multiplayer game in an example computer-based multiplayer game environment in which user interactions with game video content may be analyzed by an interaction analysis module to determine correlations between users or players and content, according to at least some embodiments. In at least some embodiments, a multiplayer game environment may include a multiplayer game system 700 and one or more client devices 720. The multiplayer game system 700 stores game data and information, implements multiplayer game logic, and serves as an execution environment for the multiplayer game. In at least some embodiments, multiplayer game system 700 may include one or more computing devices, for example one or more server devices, that implement the multiplayer game logic, and may also include other devices including but not limited to storage devices that store game data 760. However, in some embodiments, the functionality and components of game system 700 may be implemented at least in part on one or more of the client devices 720. Game data 760 may, for example, store persistent and global data for constructing and rendering the game environment/universe, such as graphical objects, patterns, and so on. Game data 760 may also store player information for particular players 750 including but not limited to the player's registration information with the game system 700, game character 752 information, client device 720 information, personal information (e.g., name, account number, contact information, etc.), security information, preferences (e.g., notification preferences), and player profiles. An example computing device that may be used in a multiplayer game system 700 is illustrated in FIG. 17.

A client device 720 may be any of a variety of consumer devices including but not limited to desktop computer systems, laptop/notebook computer systems, pad/tablet devices, smartphone devices, game consoles, handheld gaming devices, and wearable gaming devices. Wearable gaming devices may include, but are not limited to, gaming glasses or goggles and gaming “watches” or the like that are wearable on the wrist, arm, or elsewhere. Thus, client devices 720 may range from powerful desktop computers configured as gaming systems down to “thin” mobile devices such as smartphones, pad/tablet devices, and wearable devices. Each client device 720 may implement an operating system (OS) platform that is compatible with the device 720. A client device 720 may include, but is not limited to, input and output components and client software (game client 722) for the multiplayer game via which respective players 750 can participate in a multiplayer game session currently being executed by the multiplayer game system 700. The game client 722 on a particular client device 720 may be tailored to support the configuration and capabilities of the particular device 720 type and the OS platform of the device 720. An example computing device that may be used as a client device 720 is illustrated in FIG. 17.

In at least some embodiments, the multiplayer game system 700 may implement an online multiplayer game, and the multiplayer game system 700 may be or may include one or more devices on a network of a game provider that implement the online multiplayer game logic and that serve as or provide an execution environment for the online multiplayer game. In these online multiplayer game environments, game clients 720 are typically remotely located from the multiplayer game system 700 and access the game system 700 via wired and/or wireless connections over an intermediate network or networks such as the Internet. Further, client devices 720 may typically each have both input and output capabilities for playing the online multiplayer game. FIG. 16 illustrates an example provider network environment in which embodiments of a network-based game system as described herein may be implemented.

Multiplayer games that may be implemented in a multiplayer game environment as illustrated in FIG. 7 may vary from tightly scripted games to games that introduce varying amounts of randomness to the game play. The multiplayer game may, for example, be a game in which the players 750 (via their characters 752) attempt to achieve some goal or overcome some obstacle, and may include multiple levels that the players 750 have to overcome. The multiplayer game may, for example, be a game in which the players 750 cooperate to achieve goals or overcome obstacles, or a game in which one or more of the players 750 compete against one or more other players 750, either as teams or as individuals. Alternatively, a multiplayer game may be a game in which the players 750 may more passively explore and make discoveries within a complex game universe 704 without any particular goals in mind, or a “world-building” multiplayer game in which the players 750 may actively modify their environments within the game universe 704. The multiplayer games may include everything from relatively simple, two-dimensional (2D) casual games to more complex 2D or three-dimensional (3D) action or strategy games, to complex 3D massively multiplayer online games (MMOGs) such as massively multiplayer online role-playing games (MMORPGs) that may simultaneously support hundreds or thousands of players in a persistent online “world”.

In some embodiments, the game system 700 may implement interaction analysis methods via at least one interaction analysis module 740 to, for example, collect data 742 about player interactions 784 with game content within the game universe 704 using game client(s) 722, analyze the collected data 742 to determine correlations between players 750 and game content, and provide content or information targeted at particular players, users, or groups of users based at least in part on the determined correlations between players 750 and game content. The game system 700 may, for example, implement embodiments of one or more of the interactive analysis methods as illustrated in FIGS. 2 through 5. In some embodiments, interaction analysis module 740 may obtain interaction data 742 from game logic/execution 702 module(s), as shown in FIG. 7. The player interactions 784 for which the interaction data 742 is obtained or collected may, for example, include interactions exploring, manipulating, and/or modifying game content within the game universe. The player interactions 784 may include, but are not limited to, interactions navigating through, exploring, and viewing different parts of the game universe and interactions viewing, exploring, manipulating, and/or modifying objects or other game content within the game universe and according to the game client 722.

In some embodiments, to provide targeted content to players 750 or other users, the interaction analysis module 740 may analyze the information in interaction data 742 to generate analysis data 744 that may, for example, include indications of correlations between players 750 and game content, and may provide the analysis data 744 to the game logic/execution 702 module(s). The game logic/execution 702 module(s) may use the analysis data 744 in rendering new game content at least in part from game data 760 targeted at players 750 or groups of players 750 based at least in part on the analysis data 744.

In some embodiments, the interaction analysis module 740 may provide at least some analysis data 744 to one or more external systems 730, for example to one or more online merchants, other game systems, or to an RVE system. An external system 730 may, for example, use the analysis data 744 in providing information 734 targeted at particular users or groups of users based at least in part on the correlations indicated in the analysis data 744. For example, an online merchant may use the analysis data 744 to provide advertising or recommendations for products or services targeted at particular customers or potential customers via one or more channels, for example via web pages of the merchant's web site, email, or social media channels. As another example, in some embodiments, an external system 730 may use the analysis data 744 to determine or create targeted data, and may provide the targeted data (e.g., 2D or 3D models of particular products) to game data 760 for insertion into the game universe 704. As another example, an RVE system may use the analysis data 744 to provide video content targeted at particular users or groups of users based at least in part on analysis data 744 generated from users' interactions with game content in the game universe 704.

### Interaction Analysis Service

While FIGS. 1 through 7 show an interaction analysis module as a component of an RVE system or game system, in some embodiments, at least part of the interaction analysis functionality may be implemented externally to the systems from which interaction data is collected, for example as or by an interaction analysis service. FIG. 8 is a high-level illustration of an interaction analysis service and environment, according to at least some embodiments. FIGS. 2 through 5 illustrate example interaction analysis methods that may be implemented within the environment shown in FIG. 8, according to various embodiments.

As shown in FIG. 8, the environment may include one or more video systems 800. The video systems 800 may include one or more RVE systems as illustrated in FIGS. 1 and 6 and/or one or more game systems as illustrated in FIG. 7. Each video system 800 may obtain video 812 and/or graphics data 814 from one or more video and data sources 810, and process the video 812 and/or graphics data 814 to generate video 824 output that may, for example, be streamed to various client 820 devices. Each video system 800 may receive input from one or more client 820 devices indicating user interactions 822 with video content on the respective devices. The user interactions may, for example, include interactions exploring, manipulating, and/or modifying video content within 2D or 3D modeled worlds generated by the video system(s) 800 and displayed on respective client 820 devices. The video system(s) 800 may render and send new video content to the client 820 device(s) based at least in part on the user interactions with the video content.

An interaction analysis service 840 may collect or otherwise obtain data 842 describing the user interactions with video content from the video system(s) 800. In some embodiments, interaction analysis service 840 may also obtain client information 832 from one or more sources, for example from video system(s) 800 or external system(s) 830. Interaction analysis service 840 may analyze the interaction data 842 in light of client information 832 to generate analysis data 844 that, for example, correlates particular users or groups of users with particular video content. In some embodiments, interaction analysis service 840 may analyze the interaction data 842 from each video system 800 separately to generate separate analysis data 844 for each system 800. In some embodiments, instead of or in addition to analyzing the data 842 separately, the interaction analysis service 840 may collectively analyze the interaction data 842 from two or more of the video systems 800 to generate combined analysis data 844.

The interaction analysis service 840 may provide the analysis data 844 to one or more of the video systems 800. A video system 800 may, for example, use the analysis data 844 in rendering new video content targeted at users or groups based at least in part on the analysis data 844. In some embodiments, instead of or in addition to providing analysis data 844 directly to video system(s) 800, at least some analysis data 844 may be written or stored to one or more data sources 810. For example, the analysis data 844 may be used to update user and/or group profiles stored on the data sources 810. In some embodiments, the interaction analysis service 840 may provide at least some analysis data 844 to one or more external systems 830. An external system 130 may, for example, use the analysis data 844 in providing content or information targeted at particular users or groups of users based at least in part on the correlations indicated in the analysis data 844. For example, an online merchant may use the analysis data 844 to provide advertising or recommendations for products or services targeted at particular customers or potential customers via one or more channels, for example via web pages of the merchant's web site, email, or social media channels.

In some embodiments, the interaction analysis service 840 may implement one or more application programming interfaces (APIs) via which video system(s) 800 may provide interaction data 842 and other information to interaction analysis service 840, and via which analysis data 844 may be communicated to video system(s) 800, external system(s) 830, and/or video and data sources 810. In some embodiments, the interaction analysis service 840 may be implemented as a service on a provider network, for example a provider network as illustrated in FIG. 14 or 16.

### Example Real-Time Video Exploration (RVE) System and Methods

This section describes example embodiments of real-time video exploration (RVE) systems and environments in which embodiments of interaction analysis methods and modules as described herein may be implemented to analyze user interactions with video content, determine correlations between particular users and particular content, and provide the analysis data to the RVE system or to other systems for use in determining and providing content, advertising, recommendations, or other information targeted to particular users or groups of users via one or more channels. Note that, while embodiments are generally described in the context of generating, presenting, and exploring three-dimensional (3D) video content, embodiments may also be applied in the context of generating, presenting, and exploring two-dimensional (2D) video content.

Various embodiments of methods and apparatus for generating, presenting, and exploring three-dimensional (3D) modeled worlds from within pre-rendered video are described. Video, including but not limited to movies, may be produced using 3D computer graphics techniques to generate 3D modeled worlds for scenes and render two-dimensional (2D) representations of the 3D modeled worlds from selected camera viewpoints as output. In 3D video production, scene content (e.g., 3D objects, textures, colors, backgrounds, etc.) is determined for each scene, a camera viewpoint or perspective is pre-selected for each scene, the scenes (each representing a 3D world) are generated and rendered according to 3D computer graphics techniques, and the final rendered output video (e.g., a movie) includes a 2D representation of the 3D worlds, with each frame of each scene rendered and shown from a fixed, pre-selected camera viewpoint and angle, and with fixed, predetermined content. Thus, conventionally, a consumer of pre-rendered video (e.g., a movie) views the scenes in the movie from pre-selected camera viewpoints and angles, and with pre-determined content.

The 3D graphics data used in generating videos (e.g., movies) includes rich 3D content that is not presented to the viewer in conventional video, as the viewer views the scenes in the video rendered from perspectives that were pre-selected by the director, and all viewers of the video view the scenes from the same perspectives. However, the 3D graphics data may be available or may be made available, and if not available at least some 3D data may be generated from the original video, for example using various 2D-to-3D modeling techniques.

Embodiments of real-time video exploration (RVE) methods and systems are described that may leverage this 3D graphics data to enable interactive exploration of 3D modeled worlds from scenes in pre-rendered, pre-recorded video by generating and rendering new video content in real time at least in part from the 3D graphics data.

FIG. 9 is a high-level illustration of a real-time video exploration (RVE) system 10, according to at least some embodiments. Embodiments of an RVE system 10 may, for example, allow a video consumer (also referred to herein as a user or viewer), via an RVE client 30, to “step into” a scene in a video (e.g., a movie) to explore the rest of the 3D modeled world “behind the scenes” via a user-controlled, free-roaming “camera” that allows the user to change viewing positions and angles in the 3D modeled world.

In at least some embodiments, the RVE system 10 may play back video from one or more sources 20 to one or more RVE clients 30, receive user input/interactions within scenes being explored from respective RVE clients 30, responsively generate or update 3D models from graphics data obtained from one or more sources 20 in response to the user input/interactions exploring the scenes, render new video content of the scenes at least in part from the 3D models, and deliver the newly rendered video content (and audio, if present) to the respective RVE clients 30 as RVE video. Thus, rather than just viewing a pre-rendered scene in a movie from a perspective that was pre-selected by a director, a user may step into and explore the scene from different angles, wander around the scene at will within the scope of the 3D modeled world, and discover hidden objects and/or parts of the scene that are not visible in the original video as recorded. The RVE video that is output to the client(s) 30 by RVE system 10 is a video stream that has been processed and rendered according to two inputs, one input being the user's exploratory inputs, the second input being the recorded video and/or graphics data obtained from source(s) 20. In at least some embodiments, RVE system 10 may provide one or more application programming interfaces (APIs) for receiving input from and sending output to RVE client(s) 30.

Since exploring and rendering a 3D world is computationally expensive, at least some embodiments of an RVE system 10 may leverage network-based computation resources and services (e.g., a streaming service) to receive user input/interactions within a scene being explored from an RVE client 30 device, responsively generate or update a 3D model from the 3D data in response to the user input/interactions, render new video content of the scene from the 3D model, and deliver the newly rendered video content (and in some cases also audio) as a video stream to the client device in real-time or near-real-time and with low latency. The computational power available through the network-based computation resources, as well as the video and audio streaming capabilities provided through a streaming protocol, allows the RVE system 10 to provide low-latency responses to the user's interactions with the 3D world as viewed on the respective client device, thus providing a responsive and interactive exploratory experience to the user. FIG. 14 illustrates an example RVE system and environment in which network-based computation resources are leveraged to provide real-time, low-latency rendering and streaming of video content, according to at least some embodiments. FIG. 15 illustrates an example network-based environment in which a streaming service is used to stream rendered video to clients, according to at least some embodiments. FIG. 16 illustrates an example provider network environment in which embodiments of an RVE system as described herein may be implemented. FIG. 17 is a block diagram illustrating an example computer system that may be used in some embodiments.

In addition to allowing users to pause, step into, move through, and explore the 3D modeled worlds of scenes in a video, at least some embodiments of an RVE system 10 may also allow users to modify the scenes, for example by adding, removing, or modifying various graphics effects such as lens effects (e.g., fisheye, zoom, filter, etc.), lighting effects (e.g., illumination, reflection, shadows, etc.), color effects (color palette, color saturation, etc.), or various simulated effects (e.g., rain, fire, smoke, dust, fog, etc.) to the scenes.

In addition to allowing users to pause, step into, move through, explore, and even modify the 3D modeled worlds of scenes in a video, at least some embodiments of an RVE system 10 may also allow users to discover, select, explore, and manipulate objects within the 3D modeled worlds used to generate video content. At least some embodiments of an RVE system 10 may implement methods that allow users to view and explore in more detail the features, components, and/or accessories of selected objects that are being manipulated and explored. At least some embodiments of an RVE system 10 may implement methods that allow users to interact with interfaces of selected objects or interfaces of components of selected objects.

In addition to allowing users to explore scenes and manipulate objects within scenes, at least some embodiments of an RVE system 10 may allow users to interact with selected objects to customize or accessorize the objects. For example, a viewer can manipulate or interact with a selected object to add or remove accessories, customize the object (change color, texture, etc.), or otherwise modify the object according to the user's preferences or desires. In at least some embodiments, the RVE system 10 may provide an interface via which the user can obtain additional information for the object, customize and/or accessorize an object if and as desired, be given a price or price(s) for the object as customized/accessorized, and order or purchase the object as specified if desired.

At least some embodiments of an RVE system 10 may allow a user to create and record their own customized version of a video such as a movie, and/or to stream or broadcast a customized version of a video to one or more destinations in real time. Using embodiments, new versions of videos or portions of videos may be generated and may, for example, be stored or recorded to local or remote storage, shown to or shared with friends, or may be otherwise recorded, stored, shared, streamed, broadcast, or distributed assuming the acquisition of appropriate rights and permissions to share, distribute, or broadcast the new video content.

At least some embodiments of an RVE system 10 may leverage network-based computation resources and services to allow multiple users to simultaneously receive, explore, manipulate, and/or customize a pre-recorded video via RVE clients 30. The RVE system 10 may, for example, broadcast a video stream to multiple RVE clients 30, and users corresponding to the RVE clients 30 may each explore, manipulate, and/or customize the video as desired. Thus, at any given time, two or more users may be simultaneously exploring a given scene of a video being played back in real time, or may be simultaneously watching the scene from different perspectives or with different customizations, with the RVE system 10 interactively generating, rendering, and streaming new video to RVE clients 30 corresponding to the users according to the users' particular interactions with the video. Note that the video being played back to the RVE clients 30 may be pre-recorded video or may be new video generated by a user via one of the RVE clients 30 and broadcast “live” to one or more others of the RVE clients 30 via the RVE system 10.

While embodiments of the RVE system 10 are generally described as generating 3D models of scenes and objects and rendering video from the 3D models of scenes and 3D objects using 3D graphics techniques, embodiments may also be applied in generating and rendering 2D models and objects for video using 2D graphics techniques.

At least some embodiments of an RVE system 10 may implement an interaction analysis module as described herein, or may access or be integrated with an interaction analysis module as described herein. The RVE methods described in reference to RVE system 10 and RVE clients 30 may be used, for example, to pause, step into, explore, and manipulate content of video, while the interaction analysis module collects and analyzes data describing user interactions with video content to determine correlations between particular users and particular video content and provides the analysis data to one or more systems, including but not limited to the RVE system 10.

FIG. 10 is a flowchart of a method for exploring 3D modeled worlds in real-time during playback of pre-recorded video according to at least some embodiments, and with reference to FIG. 9. As indicated at 1200, an RVE system 10 may begin playback of a pre-recorded video to at least one client device. For example, an RVE control module of the RVE system 10 may direct a video playback module to begin playback of a selected video from a video source 20 to a client device in response to selection input received from an RVE client 30 on the client device. Alternatively, the RVE system 10 may begin playback of a pre-recorded video from a video source 20, and then receive input from one or more RVE clients 30 joining the playback to view (and possibly explore) the video content on respective client devices.

During playback of the pre-recorded video to the client device(s), additional input and interactions may be received by the RVE system 10 from an RVE client 30 on a client device. For example input may be received that indicates an RVE event in which the user pauses the pre-recorded video being played back to the client device so that the user can explore the current scene. As indicated at 1202, the RVE system 10 may continue to play back the pre-recorded video to the client device until the video is over as indicated at 1204, or until RVE input is received from the RVE client 30 that directs the RVE system 10 to pause the video. At 1202, if RVE input requesting a pause of the video is received from an RVE client 30, the RVE system 10 pauses the replay of the video to the client device at a current scene, as indicated at 1206.

As indicated at 1208, while the playback of the pre-recorded video is paused at a scene, the RVE system 10 may obtain and process 3D data to render new video of the scene in response to exploration input from the client device, and may stream the newly rendered video of the scene to the client device as indicated at 1210. In at least some embodiments, the RVE system 10 may begin generating a 3D modeled world for the scene from the 3D data, rendering a 2D representations of the 3D modeled world, and streaming the real-time rendered video to the respective client device in response to the pause event as indicated at 1202 and 1206. Alternatively, the RVE system 10 may begin generating a 3D modeled world for the scene from the 3D data, rendering a 2D representations of the 3D modeled world, and streaming the real-time rendered video to the respective client device upon receiving additional exploratory input received from the client device, for example input changing the viewing angle of the viewer in the scene, or input moving the viewer's viewpoint through the scene. In response to additional user input and interactions received from the client device indicating that the user is further exploring the scene, the RVE system 10 may render and stream new video of the scene from the 3D modeled world according to the current user input and 3D data, for example new video rendered from a particular position and angle within the 3D modeled world of the scene that is indicated by the user's current input to the client device. Alternatively, in some embodiments, the video may not be paused at 1206, and the method may perform elements 1208 and 1210 while the video continues playback.

In at least some embodiments, in addition to allowing users to pause, step into, move through, and explore a scene in a pre-recorded video being played back, the RVE system 10 may allow a user to modify the scene, for example by adding, removing, or modifying graphics effects such as lens effects (e.g., fisheye, zoom, etc.), lighting effects (e.g., illumination, reflection, shadows, etc.), color effects (color palette, color saturation, etc.), or various simulated effects (e.g., rain, fire, smoke, dust, fog, etc.) to the scenes.

As indicated at 1212, the RVE system 10 may continue to render and stream new video of the scene from the 3D modeled world in response to exploratory input until input is received from the client device indicating that the user wants to resume playback of the pre-recorded video. As indicated at 1214, upon receiving resume playback input, the RVE system may resume playing back the pre-recorded video to the client device. The playback may, but does not necessarily, resume at the point where the playback was paused at 1206.

In at least some embodiments, the RVE system 10 may leverage network-based computation resources and services (e.g., a streaming service) to receive the user input/interactions with video content from an RVE client 30, responsively generate or update a 3D model from the 3D data in response to the user input/interactions, render the new video content of the scene from the 3D model, and deliver the newly rendered video content (and possibly also audio) to the client device in real-time or near-real-time as a video stream. The computational power available through the network-based computation resources, as well as the video and audio streaming capabilities provided through a streaming protocol, may allow the RVE system 10 to provide low-latency responses to the user's interactions with the 3D world of the scene as viewed on the client device, thus providing a responsive and interactive exploratory experience to the user.

At least some embodiments of a real-time video exploration (RVE) system may implement methods that allow users to discover, select, explore, and manipulate objects within the 3D modeled worlds used to generate video content (e.g., scenes in movies or other video). Leveraging network-based computation resources and services and utilizing the rich 3D content and data that was used to generate and render the original, previously rendered and recorded video, an RVE system 10 may allow a viewer of a video, for example a movie, to pause and “step into” a 3D rendered scene from the video via an RVE client 30 on a client device to discover, select, explore, and manipulate objects within the scene. For example, a viewer can pause a movie at a scene and interact with one or more 3D-rendered object(s) in a scene. The viewer may select a 3D model of an object in the scene, pull up information on or relevant to the selected object, visually explore the object, and in general manipulate the object in various ways.

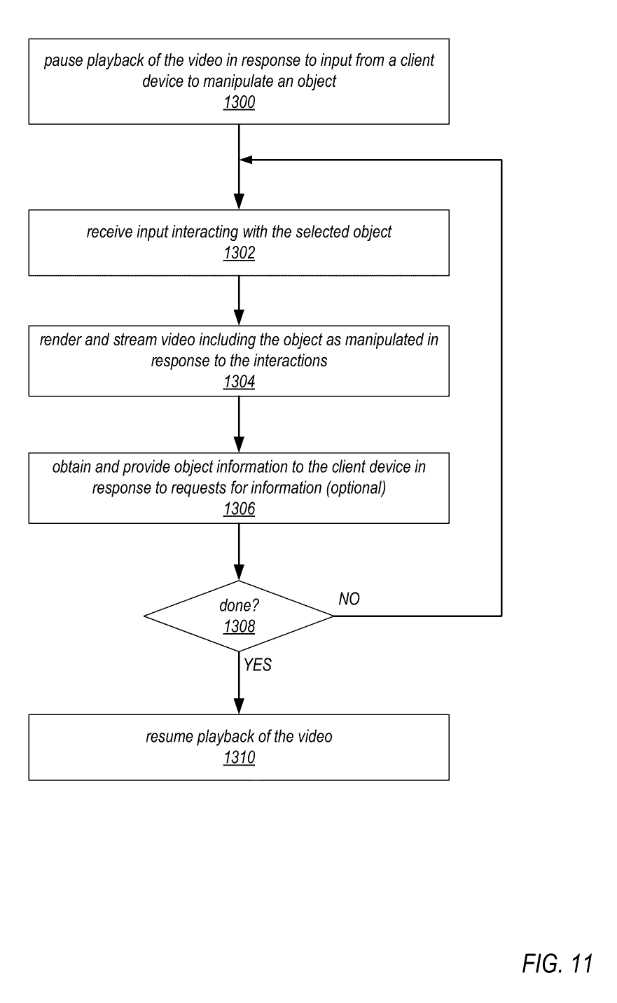

FIG. 11 is a flowchart of a method for interacting with objects and rendering new video content of the manipulated objects while exploring a pre-recorded video being played back, according to at least some embodiments, and with reference to FIG. 9. As indicated at 1300, the RVE system 10 may pause playback of a pre-recorded video being played back to a client device in response to input received from the client device to manipulate an object in a scene. In at least some embodiments, the RVE system 10 may receive input from the client device selecting an object in a scene displayed on the client device. In response, the RVE system 10 may pause the pre-recorded video being played back, obtain 3D data for the selected object, generate a 3D modeled world for the scene including a new 3D model of the object according to the obtained data, and render and stream new video of the scene to the client device.

Note that a selected object may be virtually anything that can be rendered from a 3D model. Non-limiting examples of objects that can be modeled within scenes, selected, and manipulated by embodiments include fictional or real devices or objects such as vehicles (cars, trucks, motorcycles, bicycles etc.), computing devices (smartphones tablet devices, laptop or notebook computers, etc.), entertainment devices (televisions and stereo components, game consoles, etc.), toys, sports equipment, books, magazines, CDs/albums, artwork (painting, sculptures, etc.) appliances, tools, clothes, and furniture; fictional or real plants and animals; fictional or real persons or characters; packaged or prepared foods, groceries, consumables, beverages, and so on; health care items (medicines, soap, shampoo, toothbrushes, toothpaste, etc.); and in general any living or non-living, manufactured or natural, real or fictional object, thing, or entity.

As indicated at 1302, the RVE system 10 may receive input from the client device indicating that the user is interacting with the selected object via the client device. As indicated at 1304, in response to the interactive input, the RVE system 10 may render and stream new video of the scene from the 3D modeled world including the 3D model of the object as manipulated or changed by the interactive input to the client device.

Non-limiting examples of manipulations of a selected object may include picking up an object, moving an object in the scene, rotating an object as if the object was held in the viewer's hands, manipulating movable parts of the object, or in general any physical manipulation of the object that can be simulated via 3D rendering techniques. Other examples of manipulations of an object may include changing the rendering of an object such as changing the lighting, texture, and/or color of the object, changing the opacity of the object so that the object is somewhat transparent, and so on. Other examples of object manipulations may include opening and closing doors in a house or on a vehicle, opening and closing drawers on furniture, opening and closing the, trunk, or other compartments on a vehicle, or in general any physical manipulation of components of an object that can be simulated via 3D rendering techniques. As just one non-limiting example, a user may step into a scene of a paused video to view a vehicle in the scene from all angles, open the doors and go inside the vehicle, open the console or glove compartment, and so on.

As indicated at 1306, optionally, the RVE system 10 may obtain and provide information for a selected object to the client device in response to a request for information. For example, in some embodiments, a user may double-tap on, right-click on, or otherwise select, an object to display a window of information about the object. As another example, in some embodiments, a user may double-tap on, or right-click on, a selected object to bring up a menu of object options, and select a “display info” option from the menu to obtain the object information.

Non-limiting examples of information on or relevant to a selected object that may be provided for a selected object may include descriptive information associated and possibly stored with the 3D model data or with the video being played back. In addition, the information may include, or may include links to, informational or descriptive web pages, advertisements, manufacturer or dealer web sites, reviews, BLOGs, fan sites, and so on. In general, the information that may be made available for a given object may include any relevant information that is stored with the 3D model data for the object or with the video, and/or relevant information from various other sources such as web pages or web sites. Note that an “object options” list may be displayed may include various options for manipulating a selected object, for example options to change color, texture, or other rendered features of the selected object. At least some of these options may be specific to the type of object.

As indicated at 1308, the RVE system 10 may continue to render and stream new video of the scene in response to interactive input with object(s) in the scene. In at least some embodiments, the RVE system 10 may continue to render and stream new video of the scene until input is received from the client device indicating that the user wants to resume playback of the pre-recorded video. As indicated at 1310, upon receiving resume playback input, the RVE system may resume playing back the pre-recorded video to the client device. The playback may, but does not necessarily, resume at the point where the playback was paused at 1300.

In some embodiments, when an object is selected for manipulation, or when particular manipulations are performed on the selected object by the user, the RVE system 10 may access additional and/or different 3D graphics applications and/or apply additional or different 3D graphics techniques than were originally used to generate and render the object in the scene of the video being played back, and may render the object for exploration and manipulations according to the different applications and/or techniques. For example, the RVE system 10 may use additional or different techniques to add or improve texture and/or illumination for an object being rendered for exploration and manipulation by the user.

In some embodiments, when an object is selected for manipulation, or when particular manipulations are performed on the selected object by the user, the RVE system 10 may access a different 3D model of the object than the 3D model that was originally used to generate and render the object in the scene of the video being played back, and may render a 3D representation of the object from the different 3D model for exploration and manipulation by the user. The different 3D model may be a more detailed and richer model of the object than the one originally used to render the scene, and thus may provide finer detail and a finer level of manipulation of the object than would the less detailed model. As just one non-limiting example, a user can step into a scene of a paused video to view, select, and explore a vehicle in the scene. In response to selection of the vehicle for exploration and/or manipulation, the RVE system 10 may go to the vehicle's manufacturer site or to some other external source to access detailed 3D model data for the vehicle, which may then be rendered to provide the more detailed 3D model of the vehicle to the user rather than the simpler, less detailed, and possibly less current or up-to-date model that was used in originally rendering the video.

In addition, at least some embodiments of an RVE system 10 may implement methods that allow users to view and explore in more detail the features, components, and/or accessories of selected objects that are being manipulated and explored. For example, a user may be allowed to zoom in on a selected object to view features, components, and/or accessories of the selected object in greater detail. As simple, non-limiting examples, a viewer may zoom in on a bookshelf to view titles of books, or zoom in on a table to view covers of magazines or newspapers on the table. As another non-limiting example, a viewer may select and zoom in on an object such as a notepad, screen, or letter to view the contents in greater detail, and perhaps even to read text rendered on the object. As another non-limiting example, a computing device that is rendered in the background of a scene and thus not shown in great detail may be selected, manipulated, and zoomed in on to view fine details on the device's screen or of the device's accessories and interface components such as buttons, switches, ports, and keyboards, or even model or part numbers. As another non-limiting example, an automobile that is rendered in the background of a scene and thus not shown in great detail may be selected, manipulated, and zoomed in on to view fine details of the outside of the automobile. In addition, the viewer may open the door and enter the vehicle to view interior components and accessories such as consoles, navigation/GPS systems, audio equipment, seats, upholstery, and so on, or open the hood of the vehicle to view the engine compartment.

In addition to allowing users to select and manipulate objects in a scene as described above, at least some embodiments of an RVE system 10 may implement methods that allow users to interact with interfaces of selected objects or interfaces of components of selected objects. As an example of a device and interactions with a device that may be simulated by RVE system 10, a viewer may be able to select a rendered object representing a computing or communications device such as a cell phone, smart phone, tablet or pad device, or laptop computer, and interact with the rendered interface of the device to simulate actual operations of the device. As another example of a device and interactions with a device that may be simulated by RVE system 10, a user may enter an automobile rendered on the client device and simulate operations of a navigation/GPS system in the automobile's console via the rendered representation of the navigation/GPS system's interface. The rendered object may respond appropriately to the user's interactions, for example by appropriately updating a touchscreen in response to a swipe or tap event. Reactions of a rendered object in response to the user's interactions via the rendered interface may, for example, be simulated by the RVE system 10 according to the object type and object data, or may be programmed, stored with, and accessed from the object's 3D model data or other object information.

In at least some embodiments, an RVE system 10 may leverage network-based computation resources and services (e.g., a streaming service) to receive the user's manipulations of objects in scenes on a client device, responsively generate or update 3D models of the scenes with modified renderings of the manipulated objects in response to the user input, render new video of the scenes, and deliver the newly rendered video to the client device in real-time or near-real-time as a video stream. The computational power available through the network-based computation resources, as well as the video and audio streaming capabilities provided through a streaming protocol, may allow the RVE system 10 to provide low-latency responses to the user's interactions with the objects in a scene, thus providing responsive and interactive manipulations of the objects to the user.

At least some embodiments of a real-time video exploration (RVE) system 10 may implement methods that allow users to interact with selected objects to customize or accessorize the objects. Leveraging network-based computation resources and services and utilizing 3D data for rendered objects in a video, an RVE system 10 may allow a viewer of the video, for example a movie, to pause and “step into” a 3D rendered scene from the video via an RVE client 30 on a client device to discover, select, explore, and manipulate objects within the scene. In addition, for 3D-rendered objects in a scene that can be accessorized or customized with options, the viewer can manipulate or interact with a selected object to add or remove accessories, customize the object (change color, texture, etc.), or otherwise modify the object according to the user's preferences or desires. As a non-limiting example, a user may interact with a rendering of an automobile of a scene to accessorize or customize the car. For example, the user can change the exterior color, change the interior, change the car from a hardtop to a convertible, and add, remove, or replace accessories such as navigation/GPS systems, audio systems, special wheels and tires, and so on. In at least some embodiments, and for at least some objects, the RVE system 10 may also facilitate pricing, purchasing, or ordering of an object (e.g., a car) as accessorized or customized by the user via an interface on the client device.

Since the modifications to an object are done in a 3D-rendered scene/environment, the viewer can customize and/or accessorize an object such as an automobile and then view the customized object as rendered in the 3D world of the scene, with lighting, background, and so on fully rendered for the customized object. In at least some embodiments, the user-modified object may be left in the scene when the video is resumed, and the object as it appears in the original video in this and other scenes may be replaced with the rendering of the user's modified version of the object. Using an automobile as an example, the viewer may customize a car, for example by changing it from red to blue, or from a hardtop to a convertible, and then view the customized car in the 3D modeled world of the scene, or even have the customized car used in the rest of the video once resumed.

In at least some embodiments of an RVE system 10, the ability to customize and/or accessorize objects may, for at least some objects, be linked to external sources, for example manufacturer, dealer, and/or distributor information and website(s). The RVE system 10 may provide an interface, or may invoke an external interface provided by the manufacturer/dealer/distributor, via which the user can customize and/or accessorize a selected object if and as desired (e.g., an automobile, a computing device, an entertainment system, etc.), be given a price or price(s) for the object as customized/accessorized, and even order or purchase the object as specified if desired.

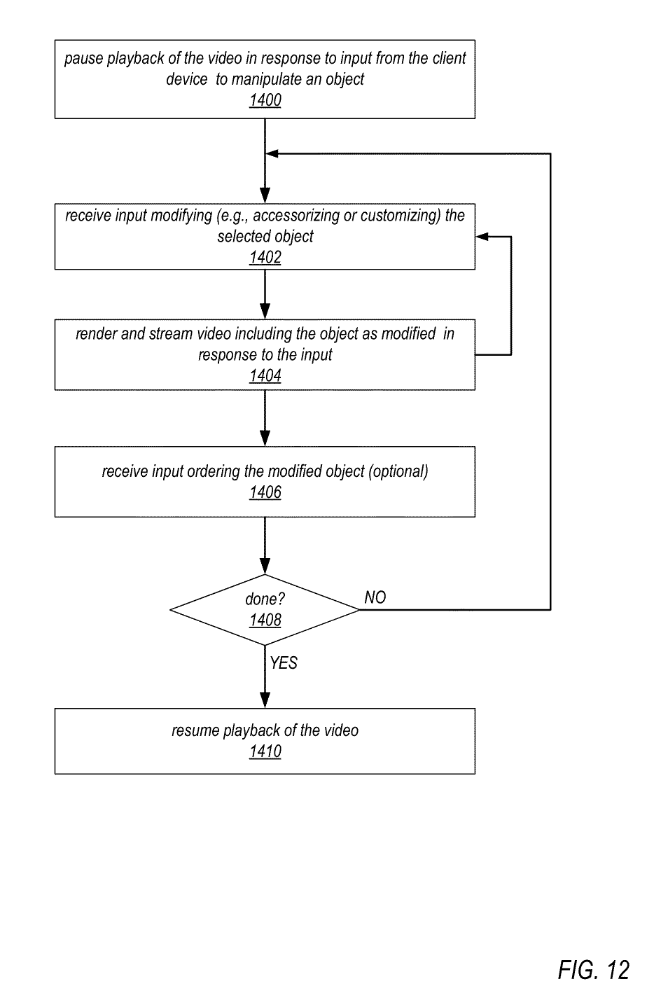

FIG. 12 is a flowchart of a method for modifying, and optionally ordering, objects while exploring a video being played back, according to at least some embodiments, and with reference to FIG. 9. As indicated at 1400, the RVE system 10 may pause playback of a pre-recorded video being played back to a client device in response to input received from the client device to manipulate an object in a scene. In at least some embodiments, the RVE system 10 may receive input from the client device selecting an object in a scene displayed on the client device. In response, the RVE system 10 may pause the pre-recorded video being played back, obtain 3D data for the selected object, generate a 3D modeled world for the scene including a new 3D model of the object according to the obtained data, and render and stream new video of the scene to the client device.

As indicated at 1402, the RVE system 10 may receive input from the client device indicating that the user is interacting with the selected object via the device to modify (e.g., accessorize or customize) the selected object. In response, the RVE system 10 may obtain additional 3D data for accessorizing or modifying the selected object, and generate a new 3D modeled world for the scene including a new 3D model of the object according to the modifications specified by the user input. As indicated at 1404, the RVE system 10 may render and stream new video of the scene from the 3D modeled world including the 3D model of the object as modified by the input to the client device.

As shown at 1406, optionally, the RVE system 10 may receive additional input from the client device requesting additional information about the object as modified (e.g., pricing, availability, vendors, dealers, etc.), and/or additional information indicating that the user wants to purchase or order the object as modified (or as originally rendered, if desired). In at least some embodiments, in response to requests for additional information, the RVE system 10 may provide additional object information (e.g., websites, links, emails, documents, advertisements, pricing, reviews, etc.) to the user via client device. In at least some embodiments, in response to a request to order or purchase an item, the RVE system 10 may provide a name, location, URL, link, email address, phone number, and/or other information indicating one or more online or brick-and-mortar sources for ordering or purchasing the object. In some embodiments, the RVE system 10 may provide a purchasing interface via which the user can order the object as modified.

As indicated at 1408, the RVE system 10 may continue to render and stream new video of the scene in response to interactions with object(s) in the scene. In at least some embodiments, the RVE system 10 may continue to render and stream new video of the scene until input is received from the client device indicating that the user wants to resume playback of the pre-recorded video. As indicated at 1410, upon receiving resume playback input, the RVE system may resume playing back the pre-recorded video to the client device. The playback may, but does not necessarily, resume at the point where the playback was paused at 1400.

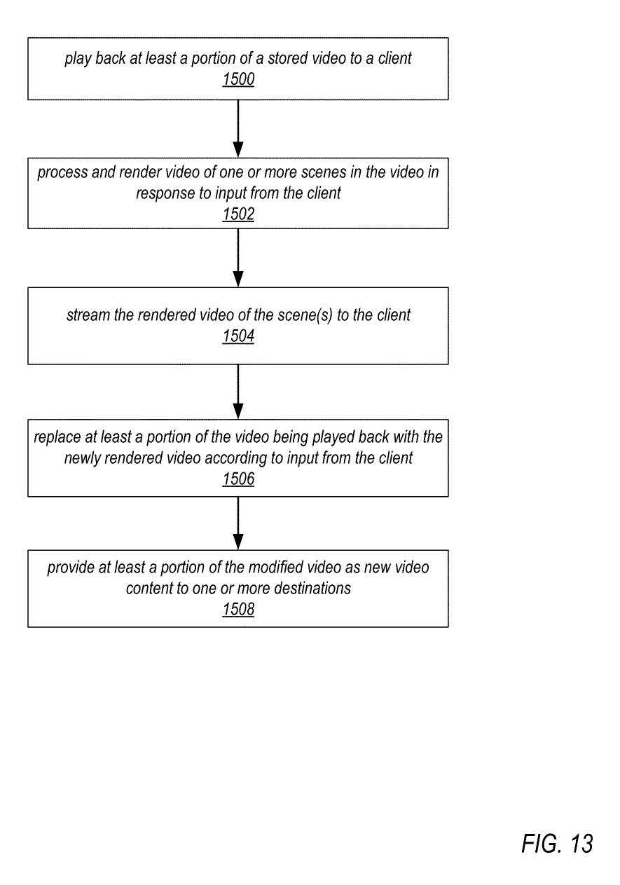

At least some embodiments of a real-time video exploration (RVE) system 10 may allow a user to generate their own customized version of a video such as a movie. The generated video may be recorded for later playback, or may be streamed or broadcast “live” to other endpoints or viewers. FIG. 13 is a flowchart of a method for rendering and storing new video content during playback of pre-recorded video, according to at least some embodiments, and with reference to FIG. 9. As indicated at 1500, an RVE system 10 may play back at least a portion of a pre-recorded video to an RVE client 30. As indicated at 1502, the RVE system 10 may process and render video of one or more scenes in the video in response to input from the RVE client 30. For example, in at least some embodiments, a user may pause a video being replayed, change the viewing angle and/or viewing position for the scene, and re-render the scene or a portion thereof using the modified viewing angle and/or position, for example using a method as described in FIG. 10. As another example, the user may manipulate, modify, customize, accessorize and/or rearrange objects in one or more scenes, for example as described in FIGS. 11 and 12. Note that one or more of these methods, or combinations of two or more of these methods, may be used to modify a given scene or portions of a scene. As indicated at 1504, the RVE system 10 may stream the newly rendered video of the scene to the RVE client 30. As indicated at 1506, at least a portion of the video being played back may be replaced with the newly rendered video according to input from the RVE client 30. For example, one or more scenes in the original video may be replaced with newly rendered scenes recorded from modified perspectives and/or including modified content to generate a new version of the original video. As indicated at 1508, at least a portion of the modified video may be provided to one or more video destinations (e.g., a video or data source 20 as illustrated in FIG. 9) as new video content. New versions of videos or portions of videos so produced may, for example, be recorded or stored to local or remote storage, shown to or shared with friends, or may be otherwise stored, shared, streamed, broadcast, or distributed assuming the acquisition of appropriate rights and permissions to share or distribute the new video content.

### Example Real-Time Video Explorer (RVE) Network Environments

Embodiments of real-time video explorer (RVE) systems that implement one or more of the various methods as described herein may be implemented in the context of a service provider that provides virtualized resources (e.g., virtualized computing resources, virtualized storage resources, virtualized database (DB) resources, etc.) on a provider network to clients of the service provider, for example as illustrated in FIG. 14. Virtualized resource instances on the provider network 2500 may be provisioned via one or more provider network services 2502 and may be rented or leased to clients of the service provider, for example to an RVE system provider 2590 that implements RVE system 2510 on provider network 2502. At least some of the resource instances on the provider network 2500 may be computing resources 2522 implemented according to hardware virtualization technology that enables multiple operating systems to run concurrently on a host computer, i.e. as virtual machines (VMs) on the host. Other resource instances (e.g., storage resources 2552) may be implemented according to one or more storage virtualization technologies that provide flexible storage capacity of various types or classes of storage to clients of the provider network. Other resource instances (e.g., database (DB) resources 2554) may be implemented according to other technologies.

In at least some embodiments, the provider network 2500, via the services 2502, may enable the provisioning of logically isolated sections of the provider network 2500 to particular clients of the service provider as client private networks on the provider network 2500. At least some of a client's resources instances on the provider network 2500 may be provisioned in the client's private network. For example, in FIG. 14, RVE system 2510 may be implemented as or in a private network implementation of RVE system provider 2590 that is provisioned on provider network 2500 via one or more of the services 2502.

The provider network 2500, via services 2502, may provide flexible provisioning of resource instances to clients in which virtualized computing and/or storage resource instances or capacity can be automatically added to or removed from a client's configuration on the provider network 2500 in response to changes in demand or usage, thus enabling a client's implementation on the provider network 2500 to automatically scale to handle computation and/or data storage needs. For example, one or more additional computing resources 2522A, 2522B, 2522C, and/or 2522D may be automatically added to RVE system 2510 in response to an increase in the number of RVE clients 2582 accessing RVE system 2510 to play back and explore video content as described herein. If and when usage drops below a threshold, computing and data storage resources that are no longer necessary can be removed.

In at least some embodiments, RVE system provider 2590 may access one or more of services 2502 of the provider network 2500 via application programming interfaces (APIs) to the services 2502 to configure and manage an RVE system 2510 on the provider network 2500, the RVE system 2510 including multiple virtualized resource instances (e.g., computing resources 2522, storage resources 2552, DB resources 2554, etc.).

Provider network services 2502 may include but are not limited to, one or more hardware virtualization services for provisioning computing resource 2522, one or more storage virtualization services for provisioning storage resources 2552, and one or more database (DB) services for provisioning DB resources 2554. In some implementations, RVE system provider 2590 may access two or more of these provider network services 2502 via respective APIs to provision and manage respective resource instances in RVE system 2510. However, in some implementations, RVE system provider 2590 may instead access a single service (e.g., a streaming service 2504) via an API to the service 2504; this service 2504 may then interact with one or more other provider network services 2502 on behalf of the RVE system provider 2590 to provision the various resource instances in the RVE system 2510.

In some embodiments, provider network services 2502 may include a streaming service 2504 for creating, deploying, and managing data streaming applications such as an RVE system 2510 on a provider network 2500. Many consumer devices, such as personal computers, tables, and mobile phones, have hardware and/or software limitations that limit the devices' capabilities to perform 3D graphics processing and rendering of video data in real time. In at least some embodiments, a streaming service 2504 may be used to implement, configure, and manage an RVE system 2510 that leverages computation and other resources of the provider network 2500 to enable real-time, low-latency 3D graphics processing and rendering of video on provider network 2500, and that implements a streaming service interface 2520 (e.g., an application programming interface (API)) for receiving RVE client 2582 input and for streaming video content including real-time rendered video as well as pre-recorded video to respective RVE clients 2582. In at least some embodiments, the streaming service 2504 may manage, for RVE system provider 2590, the deployment, scaling, load balancing, monitoring, version management, and fault detection and recovery of the server-side RVE system 2510 logic, modules, components, and resource instances. Via the streaming service 2504, the RVE system 2510 can be dynamically scaled to handle computational and storage needs, regardless of the types and capabilities of the devices that the RVE clients 2582 are implemented on.

In at least some embodiments, at least some of the RVE clients 2582 may implement an RVE client interface 2684 as shown in FIG. 15 for communicating user input and interactions to RVE system 2510 according to the streaming service interface 2520, and for receiving and processing video streams and other content received from the streaming service interface 2520. In at least some embodiments, the streaming service 2504 may also be leveraged by the RVE system provider 2590 to develop and build RVE clients 2582 for various operating system (OS) platforms on various types of client devices (e.g., tablets, smartphones, desktop/notebook computers, etc.).

Referring to FIG. 14, in at least some embodiments, data including but not limited to video content may be streamed from the streaming service interface 2520 to the RVE client 2582 according to a streaming protocol. In at least some embodiments, data including but not limited to user input and interaction may be sent to the streaming service interface 2520 from the RVE client 2582 according to the streaming protocol. In at least some embodiments, the streaming service interface 2520 may receive video content (e.g., rendered video frames) from a video playback module (not shown) and/or from a rendering 2560 module, package the video content according to the streaming protocol, and stream the video according to the protocol to respective RVE client(s) 2582 via intermediate network 2570. In at least some embodiments, an RVE client interface 2684 of the RVE client 2582 may receive a video stream from the streaming service interface 2520, extract the video content from the streaming protocol, and forward the video to a display component of the respective client device for display.

Referring to FIG. 14, an RVE system provider 2590 may develop and deploy an RVE system 2510, leveraging one or more of services 2502 to configure and provision RVE system 2510. As shown in FIG. 14, the RVE system 2510 may include and may be implemented as multiple functional modules or components, with each module or component including one or more provider network resources. In this example, RVE system 2510 includes a streaming service interface 2520 component that includes computing resources 2522A, an RVE control module 2530 that includes computing resources 2522B, 3D graphics processing 2540 module that includes computing resources 2522C, 3D graphics rendering 2560 module that includes computing resources 2522D, and data storage 2550 that includes storage resources 2552 and database (DB) resources 2554. Note that an RVE system 2510 may include more or fewer components or modules, and that a given module or component may be subdivided into two or more submodules or subcomponents. Also note that two or more of the modules or components as shown can be combined; for example, 3D graphics processing 2540 module and 3D graphics rendering 2560 module may be combined to form a combined 3D graphics processing and rendering module.

One or more computing resources 2522 may be provisioned and configured to implement the various modules or components of the RVE system 2510. For example streaming service interface 2520, RVE control module 2530, 3D graphics processing 2540 module, and 3D graphics rendering 2560 may each be implemented as or on one or more computing resources 2522. In some embodiments, two or more computing resources 2522 may be configured to implement a given module or component. For example, two or more virtual machine instances may implement an RVE control module 2530. However, in some embodiments, an instance of a given module (e.g., an instance of 3D graphics processing 2540 module, or an instance of 3D graphics rendering 2560 module) may be implemented as or on each of the computing resource 2522 instances shown in the module. For example, in some implementations, each computing resource 2522 instance may be a virtual machine instance that is spun up from a machine image implementing a particular module, for example a 3D graphics processing 2540 module, that is stored on storage resource(s) 2552.

In at least some embodiments, computing resources 2522 may be specifically provisioned or configured to support particular functional components or modules of the RVE system 2510. For example, computing resources 2522C of 3D graphics processing 2540 module and/or computing resources 2522D of 3D graphics rendering module 2560 may be implemented on devices that include hardware support for 3D graphics functions, for example graphics processing units (GPUs). As another example, the computing resources 2522 in a given module may be fronted by a load balancer provisioned through a provider network service 2502 that performs load balancing across multiple computing resource instances 2522 in the module.

In at least some embodiments, different ones of computing resources 2522 of a given module may be configured to perform different functionalities of the module. For example, different computing resources 2522C of 3D graphics processing 2540 module and/or different computing resources 2522D of 3D graphics rendering module 2560 may be configured to perform different 3D graphics processing functions or apply different 3D graphics techniques. In at least some embodiments, different ones of the computing resources 2522 of 3D graphics processing 2540 module and/or 3D graphics rendering module 2560 may be configured with different 3D graphics applications. As an example of using different 3D graphics processing functions, techniques, or applications, when rendering objects for video content to be displayed, 3D data for the object may be obtained that needs to be processed according to specific functions, techniques, or applications to generate a 3D model of the object and/or to render a 2D representation of the object for display.

Storage resources 2552 and/or DB resources 2554 may be configured and provisioned for storing, accessing, and managing RVE data including but not limited to: pre-recorded video and new video content generated using RVE system 2510; 3D data and 3D object models, and other 3D graphics data such as textures, surfaces, and effects; user information and client device information; and information and data related to videos and video content such as information about particular objects. As noted above, storage resources 2552 may also store machine images of components or modules of RVE system 2510. In at least some embodiments, RVE data including but not limited to video, 3D graphics data, object data, and user information may be accessed from and stored/provided to one or more sources or destinations eternal to RVE system 2510 on provider network 2500 or external to provider network 2500.

### Example Streaming Service Implementation

FIG. 15 illustrates an example network-based environment in which a streaming service 2504 is used to provide rendered video and sound to RVE clients, according to at least some embodiments. In at least some embodiments, an RVE environment may include an RVE system 2600 and one or more client devices 2680. The RVE system 2600 has access to stores or other sources of pre-rendered, pre-recorded video, shown as video source(s) 2650. In at least some embodiments, the RVE system 10 may also have access to stores or other sources of data and information including but not limited to 3D graphics data and user information such as viewer profiles, shown as data source(s) 2660.

RVE system 2600 may include a front-end streaming service interface 2602 (e.g., an application programming interface (API)) for receiving input from RVE clients 2682 and streaming output to RVE clients 2682, and backend data interface(s) 2603 for storing and retrieving data including but not limited to video, object, user, and other data and information as described herein. The streaming service interface 2602 may, for example, be implemented according to a streaming service 2504 as illustrated in FIG. 14. RVE system 2600 may also include video playback and recording 2606 module(s), 3D graphics processing and rendering 2608 module(s), and RVE control module 2604.

In response to user selection of a video for playback, video playback and recording 2606 module(s) may obtain pre-rendered, pre-recorded video from a video source 2650, process the video as necessary, and stream the pre-recorded video to the respective client device 2680 via streaming service interface 2602. During an RVE event in which the user pauses a video being played back, steps into a scene, and explores and possibly modifies the scene, 3D graphics processing and rendering 2608 module may obtain 3D data from one or more data sources 2660, generate a 3D modeled world for the scene according to the 3D data, render 2D representations of the 3D modeled world from user-controlled camera viewpoints, and stream the real-time rendered video to the respective client device 2680 via streaming service interface 2602. In at least some embodiments, the newly rendered video content can be recorded by video playback and recording 2606 module(s).

The RVE system 2600 may also include an RVE control module 2604 that receives input and interactions from an RVE client 2682 on a respective client device 2680 via streaming service interface 2602, processes the input and interactions, and directs operations of video playback and recording 2606 module(s) and 3D graphics processing and rendering 2608 module accordingly. In at least some embodiments, RVE control module 2604 may also track operations of video playback and recording 2606 module(s). For example, RVE control module 104 may track playback of a given video through video playback and recording 2606 module(s). module so that RVE control module 2604 can determine which scene is currently being played back to a given client device.

In at least some embodiments, RVE client 2682 may implement a streaming service client interface as RVE client interface 2684. User interactions with a video being played back to the client device 2680, for example using RVE controls implemented on the client device 2680, may be sent from client device 2680 to RVE system 2600 according to the streaming service interfaces 2684 and 2602. Rather than performing rendering of new 3D content on the client device 2680, 3D graphics processing and rendering 2608 module(s) of RVE system 2600 may generate and render new video content for scenes being explored in real-time in response to the user input received from RVE client 2680. Streaming service interface 2602 may stream video content from RVE system 2600 to RVE client 2682 according to a streaming protocol. At the client device 2680, the RVE client interface 2685 receives the streamed video, extracts the video from the stream protocol, and provides the video to the RVE client 2682, which displays the video to the client device 2680.

### Example Provider Network Environment

Embodiments of the systems and methods as described herein, including real-time video explorer (RVE) systems and methods, game systems and methods, and interaction analysis methods, modules, and services, may be implemented in the context of a service provider that provides resources (e.g., computing resources, storage resources, database (DB) resources, etc.) on a provider network to clients of the service provider. FIG. 16 illustrates an example service provider network environment in which embodiments of the systems and methods as described herein may be implemented. FIG. 16 schematically illustrates an example of a provider network 2910 that can provide computing and other resources to users 2900a and 2900b (which may be referred herein singularly as user 2900 or in the plural as users 2900) via user computers 2902a and 2902b (which may be referred herein singularly as computer 2902 or in the plural as computers 2902) via a intermediate network 2930. Provider network 2910 may be configured to provide the resources for executing applications on a permanent or an as-needed basis. In at least some embodiments, resource instances may be provisioned via one or more provider network services 2911, and may be rented or leased to clients of the service provider, for example to an RVE or game system provider 2970. At least some of the resource instances on the provider network 2910 (e.g., computing resources) may be implemented according to hardware virtualization technology that enables multiple operating systems to run concurrently on a host computer (e.g., a host 2916), i.e. as virtual machines (VMs) 2918 on the host.

The computing resources provided by provider network 2910 may include various types of resources, such as gateway resources, load balancing resources, routing resources, networking resources, computing resources, volatile and non-volatile memory resources, content delivery resources, data processing resources, data storage resources, database resources, data communication resources, data streaming resources, and the like. Each type of computing resource may be general-purpose or may be available in a number of specific configurations. For example, data processing resources may be available as virtual machine instances that may be configured to provide various services. In addition, combinations of resources may be made available via a network and may be configured as one or more services. The instances may be configured to execute applications, including services such as application services, media services, database services, processing services, gateway services, storage services, routing services, security services, encryption services, load balancing services, and so on. These services may be configurable with set or custom applications and may be configurable in size, execution, cost, latency, type, duration, accessibility, and in any other dimension. These services may be configured as available infrastructure for one or more clients and can include one or more applications configured as a platform or as software for one or more clients.

These services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices and the like.

Each type or configuration of computing resource may be available in different sizes, such as large resources consisting of many processors, large amounts of memory and/or large storage capacity, and small resources consisting of fewer processors, smaller amounts of memory and/or smaller storage capacity. Customers may choose to allocate a number of small processing resources as web servers and/or one large processing resource as a database server, for example.

Provider network 2910 may include hosts 2916a and 2916b (which may be referred herein singularly as host 2916 or in the plural as hosts 2916) that provide computing resources. These resources may be available as bare metal resources or as virtual machine instances 2918a-d (which may be referred herein singularly as virtual machine instance 2918 or in the plural as virtual machine instances 2918). Virtual machine instances 2918c and 2918d are shared state virtual machine (“SSVM”) instances. The SSVM virtual machine instances 2918c and 2918d may be configured to perform all or any portion of the RVE, game, and interaction analysis methods as described herein. As should be appreciated, while the particular example illustrated in FIG. 16 includes one SSVM 2918 virtual machine in each host, this is merely an example. A host 2916 may include more than one SSVM 2918 virtual machine or may not include any SSVM 2918 virtual machines.

The availability of virtualization technologies for computing hardware has afforded benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource.

Furthermore, some virtualization technologies may provide virtual resources that span one or more physical resources, such as a single virtual machine instance with multiple virtual processors that span multiple distinct physical computing systems.

Referring to FIG. 16, intermediate network 2930 may, for example, be a publicly accessible network of linked networks and possibly operated by various distinct parties, such as the Internet. In other embodiments, intermediate network 2930 may be a local and/or restricted network, such as a corporate or university network that is wholly or partially inaccessible to non-privileged users. In still other embodiments, intermediate network 2930 may include one or more local networks with access to and/or from the Internet.

Intermediate network 2930 may provide access to one or more client devices 2902. User computers 2902 may be computing devices utilized by users 2900 or other customers of provider network 2910. For instance, user computer 2902a or 2902b may be a server, a desktop or laptop personal computer, a tablet computer, a wireless telephone, a personal digital assistant (PDA), an e-book reader, a game console, a set-top box or any other computing device capable of accessing provider network 2910 via wired and/or wireless communications and protocols. In some instances, a user computer 2902a or 2902b may connect directly to the Internet (e.g., via a cable modem or a Digital Subscriber Line (DSL)). Although only two user computers 2902a and 2902b are depicted, it should be appreciated that there may be multiple user computers.

User computers 2902 may also be utilized to configure aspects of the computing, storage, and other resources provided by provider network 2910 via provider network services 2911. In this regard, provider network 2910 might provide a gateway or web interface through which aspects of its operation may be configured through the use of a web browser application program executing on a user computer 2902. Alternatively, a stand-alone application program executing on a user computer 2902 might access an application programming interface (API) exposed by a service 2911 of provider network 2910 for performing the configuration operations. Other mechanisms for configuring the operation of various resources available at provider network 2910 might also be utilized.

Hosts 2916 shown in FIG. 16 may be standard host devices configured appropriately for providing the computing resources described above and may provide computing resources for executing one or more services and/or applications. In one embodiment, the computing resources may be virtual machine instances 2918. In the example of virtual machine instances, each of the hosts 2916 may be configured to execute an instance manager 2920a or 2920b (which may be referred herein singularly as instance manager 2920 or in the plural as instance managers 2920) capable of executing the virtual machine instances 2918. An instance manager 2920 may be a hypervisor or virtual machine monitor (VMM) or another type of program configured to enable the execution of virtual machine instances 2918 on a host 2916, for example. As discussed above, each of the virtual machine instances 2918 may be configured to execute all or a portion of an application or service.

In the example provider network 2910 shown in FIG. 16, a router 2914 may be utilized to interconnect the hosts 2916a and 2916b. Router 2914 may also be connected to gateway 2940, which is connected to intermediate network 2930. Router 2914 may be connected to one or more load balancers, and alone or in combination may manage communications within provider network 2910, for example, by forwarding packets or other data communications as appropriate based on characteristics of such communications (e.g., header information including source and/or destination addresses, protocol identifiers, size, processing requirements, etc.) and/or the characteristics of the network (e.g., routes based on network topology, subnetworks or partitions, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example provider network 2910 shown in FIG. 16, a host manager 2915 may also be employed to at least in part direct various communications to, from and/or between hosts 2916a and 2916b. While FIG. 16 depicts router 2914 positioned between gateway 2940 and host manager 2915, this is given as an example configuration and is not intended to be limiting. In some cases, for example, host manager 2915 may be positioned between gateway 2940 and router 2914. Host manager 2915 may, in some cases, examine portions of incoming communications from user computers 2902 to determine one or more appropriate hosts 2916 to receive and/or process the incoming communications. Host manager 2915 may determine appropriate hosts to receive and/or process the incoming communications based on factors such as an identity, location or other attributes associated with user computers 2902, a nature of a task with which the communications are associated, a priority of a task with which the communications are associated, a duration of a task with which the communications are associated, a size and/or estimated resource usage of a task with which the communications are associated and many other factors. Host manager 2915 may, for example, collect or otherwise have access to state information and other information associated with various tasks in order to, for example, assist in managing communications and other operations associated with such tasks.

It should be appreciated that the network topology illustrated in FIG. 16 has been greatly simplified and that many more networks and networking devices may be utilized to interconnect the various computing systems disclosed herein. These network topologies and devices should be apparent to those skilled in the art.

It should also be appreciated that provider network 2910 described in FIG. 16 is given by way of example and that other implementations might be utilized. Additionally, it should be appreciated that the functionality disclosed herein might be implemented in software, hardware or a combination of software and hardware. Other implementations should be apparent to those skilled in the art. It should also be appreciated that a host, server, gateway or other computing device may comprise any combination of hardware or software that can interact and perform the described types of functionality, including without limitation desktop or other computers, database servers, network storage devices and other network devices, PDAs, tablets, cell phones, wireless phones, pagers, electronic organizers, Internet appliances, television-based systems (e.g., using set top boxes and/or personal/digital video recorders), game systems and game controllers, and various other consumer products that include appropriate communication and processing capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

### Illustrative System

In at least some embodiments, a computing device that implements a portion or all of the technologies as described herein may include a general-purpose computer system that includes or is configured to access one or more computer-readable media, such as computer system 3000 illustrated in FIG. 17. In the illustrated embodiment, computer system 3000 includes one or more processors 3010 coupled to a system memory 3020 via an input/output (I/O) interface 3030. Computer system 3000 further includes a network interface 3040 coupled to I/O interface 3030.

In various embodiments, computer system 3000 may be a uniprocessor system including one processor 3010, or a multiprocessor system including several processors 3010 (e.g., two, four, eight, or another suitable number). Processors 3010 may be any suitable processors capable of executing instructions. For example, in various embodiments, processors 3010 may be general-purpose or embedded processors implementing any of a variety of instruction set architectures (ISAs), such as the x86, PowerPC, SPARC, or MIPS ISAs, or any other suitable ISA. In multiprocessor systems, each of processors 3010 may commonly, but not necessarily, implement the same ISA.

System memory 3020 may be configured to store instructions and data accessible by processor(s) 3010. In various embodiments, system memory 3020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 3020 as code 3025 and data 3026.

In one embodiment, I/O interface 3030 may be configured to coordinate I/O traffic between processor 3010, system memory 3020, and any peripheral devices in the device, including network interface 3040 or other peripheral interfaces. In some embodiments, I/O interface 3030 may perform any necessary protocol, timing or other data transformations to convert data signals from one component (e.g., system memory 3020) into a format suitable for use by another component (e.g., processor 3010). In some embodiments, I/O interface 3030 may include support for devices attached through various types of peripheral buses, such as a variant of the Peripheral Component Interconnect (PCI) bus standard or the Universal Serial Bus (USB) standard, for example. In some embodiments, the function of I/O interface 3030 may be split into two or more separate components, such as a north bridge and a south bridge, for example. Also, in some embodiments some or all of the functionality of I/O interface 3030, such as an interface to system memory 3020, may be incorporated directly into processor 3010.

Network interface 3040 may be configured to allow data to be exchanged between computer system 3000 and other devices 3060 attached to a network or networks 3050, such as other computer systems or devices, for example. In various embodiments, network interface 3040 may support communication via any suitable wired or wireless general data networks, such as types of Ethernet network, for example. Additionally, network interface 3040 may support communication via telecommunications/telephony networks such as analog voice networks or digital fiber communications networks, via storage area networks such as Fibre Channel SANs, or via any other suitable type of network and/or protocol.

In some embodiments, system memory 3020 may be one embodiment of a computer-readable medium configured to store program instructions and data as described above for implementing embodiments of the corresponding methods and apparatus. However, in other embodiments, program instructions and/or data may be received, sent or stored upon different types of computer-readable media. Generally speaking, a computer-readable medium may include non-transitory storage media or memory media such as magnetic or optical media, e.g., disk or DVD/CD coupled to computer system 3000 via I/O interface 3030. A non-transitory computer-readable storage medium may also include any volatile or non-volatile media such as RAM (e.g. SDRAM, DDR SDRAM, RDRAM, SRAM, etc.), ROM, etc, that may be included in some embodiments of computer system 3000 as system memory 3020 or another type of memory. Further, a computer-readable medium may include transmission media or signals such as electrical, electromagnetic, or digital signals, conveyed via a communication medium such as a network and/or a wireless link, such as may be implemented via network interface 3040.

### CONCLUSION

Various embodiments may further include receiving, sending or storing instructions and/or data implemented in accordance with the foregoing description upon a computer-readable medium. Generally speaking, a computer-readable medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc, as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

The invention claimed is:

1. A system, comprising:
one or more computing devices configured to implement a real-time video exploration (RVE) system configured to:
stream video to a plurality of client devices;
receive input from one or more of the client devices indicating user interactions exploring video content in the streamed video, wherein the video content includes graphical representations of objects rendered from graphics data according to one or more computer graphics techniques;
render new video content from the graphics data based at least in part on the user interactions with the video content; and
stream video including the new video content to respective ones of the one or more client devices;
one or more computing devices configured to implement an interaction analysis module configured to:
obtain interaction data from the RVE system indicating at least some of the user interactions exploring the video content in the streamed video;
analyze the interaction data to determine correlations between users or groups of users and the video content in the streamed video; and
provide analysis data indicating the determined correlations to one or more systems;
wherein the one or more systems are configured to provide additional content or information targeted at particular users or groups of users based at least in part on the determined correlations as indicated in the analysis data.

2. The system as recited in claim 1, wherein the one or more systems include the RVE system, and wherein the RVE system is further configured to render new video content targeted at the particular users or groups of users based at least in part on the determined correlations as indicated in the analysis data and stream video including the targeted new video content to respective ones of the client devices.

3. The system as recited in claim 1, wherein at least one of the one or more systems is configured to provide, via one or more communications channels, information, advertising or recommendations for particular products or services targeted at the particular users or groups of users based at least in part on the determined correlations as indicated in the analysis data.

4. The system as recited in claim 1, wherein the interaction analysis module is further configured to correlate client information from one or more sources with the interaction data to associate particular users' interaction data with the particular users' client information, wherein the client information includes client identity information and client profile information for a plurality of users, and wherein the analysis data further indicates associations between the client information and the interaction data.

5. The system as recited in claim 1, wherein the interaction analysis module is implemented as an interaction analysis service on a provider network, wherein the interaction data is obtained from the RVE system according to an application programming interface (API) of the service, and wherein the analysis data is provided to the one or more systems according to the API.

6. The system as recited in claim 5, wherein the interaction analysis service is configured to:
obtain interaction data from at least one other RVE system indicating user interactions with video content in videos streamed by the at least one other RVE system;
combine the interaction data from the RVE systems and analyze the combined interaction data to determine correlations between users or groups of users and the video content in the videos based on the analysis of the combined interaction data; and
provide analysis data indicating the correlations determined based on the combined interaction data to at least one of the one or more systems.

7. The system as recited in claim 1, wherein the interaction analysis module is a component of the RVE system.

8. The system as recited in claim 1, wherein the one or more computing devices that implement the RVE system are on a provider network, and wherein the RVE system is configured to leverage one or more computing resources of the provider network to perform said rendering new video content and said streaming video including the new video content to the one or more client devices in real time during playback of pre-recorded video to the plurality of client devices.

9. A method, comprising:
receiving, by a video system implemented on one or more computing devices, input from one or more of a plurality of client devices indicating user interactions with video content in video sent to the plurality of client devices by the video system, wherein the video content includes graphical representations of objects rendered from graphics data according to one or more computer graphics techniques;
rendering and sending new video content from the graphics data based at least in part on the user interactions with the video content
sending video including the new video content to respective ones of the one or more client devices;
analyzing, by an interaction analysis module, the user interactions with the video content in the video to determine correlations between at least one user and particular objects represented by the video content; and
providing additional content or information targeted at one or more particular users based at least in part on the determined correlations.

10. The method as recited in claim 9, wherein said providing additional content or information targeted at one or more particular users based at least in part on the determined correlations comprises rendering new video content targeted at the one or more particular users based at least in part on the determined correlations and sending video including the targeted new video content to respective client devices of the one or more particular users.

11. The method as recited in claim 9, wherein the video system is a real-time video exploration (RVE) system, and wherein said providing additional content or information targeted at one or more particular users based at least in part on the determined correlations comprises:
updating, by the interaction analysis module, profiles for one or more users maintained by the RVE system to indicate determined correlations between the users and particular objects represented by the video content;
rendering, by the RVE system, new video content targeted at the one or more particular users based at least in part on the correlations indicated in the particular users' profiles; and
sending video including the targeted new video content to respective client devices of the one or more particular users.

12. The method as recited in claim 9, wherein said providing additional content or information targeted at one or more particular users based at least in part on the determined correlations comprises providing information, advertising or recommendations for particular products or services to the particular users via one or more communications channels.

13. The method as recited in claim 9, further comprising correlating client information from one or more sources with the user interactions to associate particular users' interactions with the video content with the particular users' client information, wherein the client information includes client identity information and client profile information for a plurality of users.

14. The method as recited in claim 9, wherein the video system is a real-time video exploration (RVE) system or an online game system.

15. The method as recited in claim 9, wherein the interaction analysis module is implemented as an interaction analysis service, the method further comprising:
receiving, by the interaction analysis service from two or more video systems, interaction data indicating user interactions with video content in respective videos;
analyzing, by the interaction analysis module, the received interaction data from the two or more video systems to determine correlations between particular users or groups of users and particular objects represented by the video content in the respective videos; and
providing analysis data indicating the determined correlations to one or more systems.

16. A non-transitory computer-readable storage medium storing program instructions that when executed on one or more computers cause the one or more computers to implement a real-time video exploration (RVE) system configured to:
receive input from one or more client devices indicating user interactions with content of video streamed to the one or more client devices, wherein the video includes one or more scenes rendered at least in part according to one or more computer graphics techniques;
analyze the user interactions with the content of the streamed video to determine correlations between at least one user and particular video content in the streamed video;
render new video content targeted at one or more users based at least in part on the determined correlations, wherein the new video content includes graphical representations of objects rendered from graphics data according to one or more computer graphics techniques; and
stream video including the targeted new video content to respective client devices of the one or more users.

17. The non-transitory computer-readable storage medium as recited in claim 16, wherein the input is received from the one or more client devices according to an application programming interface (API) of the RVE system.

18. The non-transitory computer-readable storage medium as recited in claim 16, wherein the targeted new video content is different for at least two of the plurality of client devices.

19. The non-transitory computer-readable storage medium as recited in claim 16, wherein the targeted new video content for a particular user includes renderings of particular objects or types of objects selected for the user at least in part according to the user's interactions with the video content in the streamed video.

20. The non-transitory computer-readable storage medium as recited in claim 16, wherein the RVE system is configured to perform said rendering new video content and said streaming video including the targeted new video content to respective client devices in real time during playback of pre-recorded video to the plurality of client devices.

21. The non-transitory computer-readable storage medium as recited in claim 16, wherein, to render new video content targeted at one or more users based at least in part on the determined correlations, the RVE system is configured to:
determine one or more groups of users at least in part according to the determined correlations; and
render the new video content targeted at the one or more users based at least in part on the determined one or more groups of users.

22. The non-transitory computer-readable storage medium as recited in claim 16, wherein, to render new video content targeted at one or more users based at least in part on the determined correlations, the RVE system is configured to render new video content targeted at one or more groups of users based at least in part on the determined correlations between a particular user and particular video content in the streamed video.
